(19) United States
(12) Patent Application Publication
(10) Pub. No.: US 2019/0161414 A1
(43) Pub. Date: May 30, 2019

(54) CERAMICS PROCESSING

(71) Applicant: IMERTECH SAS, Paris (FR)

(72) Inventors: Isabel Ferro GIMÉNEZ, Cuntis (Pontevedra) (ES); Romain PEYRE, Narbonne (FR); Javier del Río ÁLVAREZ, Gijón (Asturias) (ES); Magdalena González CASTRO, Tomino (Pontevedra) (ES); Pascual Garcia PÉREZ, Alboraya (Valencia) (ES)

(21) Appl. No.: 16/321,160

(22) PCT Filed: Jul. 27, 2017
(86) PCT No.: PCT/EP2017/069071

§ 371 Date: Jan. 28, 2019

(30) Foreign Application Priority Data
Jul. 28, 2016 (EP) 16305987.6

(51) Int. Cl. C04B 38/00

(52) U.S. Cl. CPC C04B 38/0012; C04B 38/0009; C04B 2235/6021; C04B 2235/616; C04B 2235/606

(57) ABSTRACT

Methods for ceramic processing, for example a method for removing water from a ceramic green body, a method for extruding a ceramic composition, a method of plugging a ceramic honeycomb structure, and a method for coating a ceramic honeycomb structure with a skin composition, and related products.

### TECHNICAL FIELD

The present invention relates generally to the processing of ceramic compositions and the products made by said processes. For example, in one aspect the present invention relates to methods of drying a ceramic green body, which may, for example, reduce differential shrinking and consequential cracking of the ceramic composition. In another aspect, the present invention relates to a method of extruding a ceramic composition which involves controlling the temperature of different regions of the ceramic composition such that they have different temperatures prior to and/or during extrusion. In certain embodiments, this may result in substantially uniform flow of the ceramic composition and consequently reduce bowing of the extruded ceramic composition. In a further aspect, there is provided the use of a plugging composition to fill an opening of one or more cells of a ceramic honeycomb structure, wherein the plugging composition has a sintering shrinkage that is equal to or up to about 0.2 percentage points less than the sintering shrinkage of the ceramic honeycomb structure. In a further aspect, there is provided the use of an adhesive in an outer skin composition for a ceramic honeycomb structure.

### BACKGROUND

Ceramic structures, particularly ceramic honeycomb structures, are known in the art for the manufacture of filters for liquid and gaseous media. The most relevant application today is in the use of such ceramic structures as particle filters for the removal of fine particles from the exhaust gas of engines of vehicles (e.g. diesel particulates), since these fine particles have been shown to have negative influence on human health.

A summary on the ceramic materials known for this application is given in the paper of J. Adler, Int. J. Appl. Ceram. Technol. 2005, 2(6), p 429-439, the content of which is incorporated herein in its entirety for all purposes.

Several ceramic materials have been described for the manufacture of ceramic honeycomb filters suitable for that specific application.

For example, honeycombs made from ceramic materials based on mullite and tialite have be used for the construction of diesel particulate filters. Mullite is an aluminium and silicon containing silicate mineral of variable composition between the two defined phases [3Al₂O₃.2SiO₂] (the so-called “stoichiometric” mullite or “3:2 mullite”) and [2Al₂O₃.1SiO₂] (the so-called “2:1 mullite”). The material is known to have a high melting point and fair mechanical properties, but relatively poor thermal shock properties. Tialite is an aluminium titanate having the formula [Al₂Ti₂O₅]. The material is known to show a high thermal shock resistance, low thermal expansion and a high melting point.

Owing to these properties, tialite has traditionally been a favoured material of choice for the manufacture of honeycomb structures. For example, US-A-20070063398 describes porous bodies for use as particulate filters comprising over 90% tialite. Similarly, US-A-20100230870 describes ceramic bodies suitable for use as particulate filters having an aluminium titanate content of over 90 mass %.

Attempts have also been made to combine the positive properties of mullite and tialite, e.g., by developing ceramic materials comprising both phases.

WO-A-2009/076985 describes a ceramic honeycomb structure comprising a mineral phase of mullite and a mineral phase of tialite. The examples describe a variety of ceramic structures typically comprising at least about 65 vol. % mullite and less than 15 vol. % tialite. According to one example, a honeycomb consisting of 72% 3:2 mullite, 13% andalusite, 8% amorphous phase and 7% tialite was prepared. The honeycomb had a total porosity of 47.5% and a standard three point modulus of rupture (MOR) test along the axis of the sample showed a fracture force of 99N.

Processing of ceramic materials generally involves preparing a ceramic composition by mixing the various minerals and other materials that make-up the ceramic material, forming the mixture into a desired shape (e.g. by extrusion) to form a ceramic green body, drying the ceramic green body to remove water, and then sintering the dried ceramic article. The surface of the sintered ceramic article may then, for example, be coated with a skin layer, which may protect the ceramic article from rapid temperature changes and/or increased pressure.

The precise manner in which these steps are executed will affect the product of the process. For example, common problems that may arise during processing of a ceramic composition include, for example, cracking of the ceramic material during drying (e.g. due to differential or rapid shrinkage of the ceramic material), bowing or deformation of a ceramic material during extrusion, deformation or leakage of cells of a ceramic honeycomb following sintering (e.g. due to differential shrinkage between the honeycomb structure and the plugging composition used to fill the cell openings) and low adhesion, low mechanical resistance or high shrinkage of a ceramic skin composition. It is therefore desirable to produce alternative or improved processes, which may, for example, improve one or more of these problems.

### SUMMARY

In accordance with a first aspect of the present invention there is provided a method for removing water from a ceramic green body, the method comprising immersing the ceramic green body in an organic liquid in a container, wherein the organic liquid is at a temperature sufficient to vaporize water in the ceramic green body, and removing the mixture of vaporized water and organic liquid from the chamber.

In accordance with a second aspect of the present invention there is provided a ceramic composition or article made by the method of the first aspect of the present invention.

In accordance with a third aspect of the present invention there is provided method for extruding a ceramic composition, the method comprising differentially controlling the temperature of different regions of the ceramic composition prior to and/or during extrusion.

In accordance with a fourth aspect of the present invention there is provided a ceramic article made by the method of the third aspect of the present invention.

In accordance with a fifth aspect of the present invention there is provided a device for differentially controlling the temperature of a ceramic composition before and/or during extrusion, wherein the device interacts with the ceramic composition and wherein the device comprises regions in which temperature can be independently controlled.

In accordance with a sixth aspect of the present invention there is provided a plugging composition for filling the openings of one or more cells of a ceramic honeycomb structure.

In certain embodiments, the plugging composition has a sintering shrinkage that is equal to or up to about 0.2% less than the sintering shrinkage of the ceramic honeycomb structure in which it is to be used.

In certain embodiments, the plugging composition comprises:
from about 19 wt % to about 21.5 wt % of a tialite precursor having a d₅₀ of less than 1 μm;
from about 7 wt % to about 9.5 wt % of a tialite precursor having a d₅₀ ranging from about 15 μm to about 20 μm;
from about 23 wt % to about 26 wt % of one or more aluminosilicate precursor(s) having a d₅₀ ranging from about 30 μm to about 45 μm;
from about 15 wt % to about 20 wt % of an alumina having a d₅₀ ranging from about 25 μm to about 35 μm;
from about 23 wt % to about 28 wt % of an alumina having a d₅₀ ranging from about 2 μm to about 4 μm;
from about 0 wt % to about 5 wt % of a zirconia precursor; and
from about 0 wt % to about 3 wt % of a magnesium source.

In accordance with a seventh aspect of the present invention there is provided a ceramic honeycomb structure having one or more cells plugged with a plugging composition according to the sixth aspect of the present invention.

In accordance with an eighth aspect of the present invention there is provided a use of a plugging composition according to the sixth aspect of the present invention to fill one or more cell openings in a ceramic honeycomb structure.

In accordance with a ninth aspect of the present invention there is provided a method of filling one or more cell openings of a ceramic honeycomb structure, the method comprising using the plugging composition of the sixth aspect of the present invention.

In accordance with a tenth aspect of the present invention there is provided the use of an adhesive in an outer skin composition for a ceramic honeycomb structure.

In accordance with an eleventh aspect of the present invention there is provided a skin composition comprising an adhesive.

In accordance with a twelfth aspect of the present invention there is provided a ceramic honeycomb structure coated with a skin composition of the eleventh aspect of the present invention.

In accordance with a thirteenth aspect of the present invention there is provided an extrusion die (e.g. a ceramic extrusion die) comprising or made of a HWS-isotropic steel.

In accordance with a fourteenth aspect of the present invention there is provided a method for removing water from a ceramic green body, the method comprising immersing the ceramic green body in an organic liquid in a container, wherein the organic liquid replaces the water in the ceramic green body, and removing the mixture of organic liquid and water from the container.

In accordance with a fifteenth aspect of the present invention there is provided a ceramic composition or article made by the method of the fourteenth aspect of the present invention.

Certain embodiments of the present invention may provide one or more of the following advantages:
uniform drying of ceramic green body;
uniform shrinking of ceramic green body;
reduced or no cracking of ceramic green body upon drying;
easy separation of water from organic liquid used for drying;
control of the shape of an extruded article by controlling flow of the ceramic material through the extrusion die (e.g. reduced bowing of ceramic honeycomb structure);
reduce leakage and/or deformation of plugged honeycomb structures;
improved adhesion of skin layer to ceramic composition;
improved mechanical resistance of ceramic composition.

The details, examples and preferences provided in relation to any particular one or more of the stated aspects of the present invention apply equally to all aspects of the present invention. Any combination of the aspects, embodiments, examples and preferences described herein in all possible variations thereof is encompassed by the present invention unless otherwise indicated herein, or otherwise clearly contradicted by context.

### DETAILED DESCRIPTION

### Drying Process

There is provided herein a method for drying (removing water from) a ceramic green body. In certain embodiments, the method removes at least about 70 wt % of water from the ceramic green body. In certain embodiments, the method removes at least about 75 wt % or at least about 80 wt % or at least about 85 wt % or at least about 90 wt % or at least about 95 wt % or at least about 96 wt % or at least about 97 wt % or at least about 98 wt % of the water from the ceramic green body. In certain embodiments, the method removes up to about 90 wt % or up to about 95 wt % or up to about 96 wt % or up to about 97 wt % or up to about 98 wt % or up to about 99 wt % or up to 100 wt % of the water from the ceramic body. For example, the method may remove from about 90 wt % to about 99 wt % of water from the ceramic body.

In certain embodiments, the method may also remove organic compounds from the ceramic green body. For example, the percentage of organic compounds removed from the ceramic green body is less than the percentage of water removed from the ceramic green body.

The term ceramic green body refers to a weakly bound ceramic composition that has not been sintered. The ceramic green body may, for example, comprise a bonded powder, which may, for example, comprise a ceramic powder and a binder. The drying method may be used to simultaneously dry one or more ceramic green bodies. For example, the drying method may be used to simultaneously dry up to about 50 or up to about 40 or up to about 30 ceramic green bodies. For example, the ceramic green bodies may be placed in the same container.

The term ceramic refers to an inorganic, non-metallic material, which may, for example, be able to withstand high temperatures (e.g. up to 1600° C.). The ceramic may, for example, be a crystalline oxide, nitride and/or carbide material. The ceramic material raw materials may, for example, include clay minerals such as kaolinite, alumina, tialite, mullite and/or precursors thereof, for example as described herein.

The ceramic green body may be formed of any suitable ceramic material. In certain embodiments, the ceramic green body may comprise one or more of aluminosilicate precursors, silicon carbide (SiC), silicon nitride, mullite, cordierite, zirconia, zirconia precursors, titania, silica, magnesia, alumina, spinel, tialite, tialite precursors, kyanite, sillimanite, andalusite, lithium aluminium silicate, aluminium titanate and mixtures thereof. The ceramic material may contain metals, such as magnesium, Fe—Cr—Al based metal, metal silicon and the like. Tialite precursors include, for example TiO₂, for example anatase and/or rutile. Aluminosilicate precursors include, for example, mullite precursors such as andalusite. Zirconia precursors include, for example, zirconium oxide (e.g. fused zirconium oxide). Magnesium precursors include, for example, magnesium carbonate.

The method comprises immersing the ceramic green body in an organic liquid in a container.

The term “immerse” means that the ceramic green body is completely covered by the organic liquid. Where the ceramic green body is a ceramic honeycomb structure, the organic liquid preferably enters the cells/channels of the honeycomb structure.

The term “organic liquid” refers to any organic compound that is in the form of a liquid during the immersing step.

The term “container” refers to a vessel that can hold the organic liquid. The container may, for example, be a “chamber”, which refers to an enclosed space or cavity in which the organic liquid can be held (closed off on all sides). The chamber, may, for example, be hermetically sealed (excludes the passage of air and other gases). The pressure inside the chamber may therefore be controlled (e.g. decreased) as described herein. The doors of the chamber may, for example, comprise a blocking system to enable the chamber to become hermetically sealed. The chamber may, for example, indicate to a user when a hermetic seal is in place, for example by a light on the doors.

The organic liquid in which the ceramic green body is immersed may be at a temperature sufficient to vaporize water in the ceramic green body. This refers to the temperature at which water transitions from a liquid to a vapour and may include evaporation and/or boiling. In this embodiment, the temperature of the organic liquid provides the energy required for vaporization (i.e. acts as a heat-transfer liquid). During the immersion step, both the temperature inside the chamber and the temperature of the organic liquid in the chamber is measured in order to determine the temperature of the organic liquid that is required to provide the energy required to vaporize water in the ceramic green body. Without wishing to be bound by theory, it is thought that the organic liquid (e.g. organic liquid that is miscible with water such as, for example, acetone or isopropanol) may replace the water that is removed from the ceramic green bodies during the immersion step and/or the organic liquid creates an equilibrium gradient with the water in the ceramic green bodies that causes it to be removed from the ceramic green bodies.

The temperature sufficient to vaporize water in a ceramic green body is dependent on the pressure of the enclosed system in which the method is carried out. Reducing the pressure inside an enclosed system reduces the vaporization temperature of water in the system. Therefore the “temperature sufficient to vaporize water in the ceramic green body” varies depending on the pressure of the system in which the method is carried out. The related temperatures and pressure can be determined by a person skilled in the art.

In certain embodiments, the temperature of the organic liquid is therefore equal to or greater than the vaporization temperature of water in the ceramic green bodies. For example, the temperature of the organic liquid may be at least about 5° C. or at least about 6° C. or at least about 7° C. or at least about 8° C. or at least about 9° C. or at least about 10° C. greater than the vaporization temperature of the water. The temperature of the organic liquid may, for example, be up to about 50° C. greater than the vaporization temperature of the water in the ceramic green bodies. For example, the vaporization temperature of the water may be up to about 45° C. or up to about 40° C. or up to about 35° C. or up to about 30° C. or up to about 25° C. or up to about 20° C. greater than the vaporization temperature of the water in the ceramic green bodies.

In certain embodiments, the temperature of the organic liquid is equal to or less than about 100° C. For example, the temperature of the organic liquid may be equal to or less than about 95° C. or equal to or less than about 90° C. or equal to or less than about 85° C. or equal to or less than about 80° C. or equal to or less than about 75° C. or equal to or less than about 70° C. or equal to or less than about 65° C. or equal to or less than about 60° C. or equal to or less than about 55° C. or equal to or less than about 50° C. For example, the temperature of the organic liquid may be at least about 30° C. or at least about 35° C. or at least about 40° C. or at least about 45° C. For example, the temperature of the organic liquid may range from about 40° C. to about 90° C. or from about 40° C. to about 85° C. or from about 40° C. to about 80° C. or from about 40° C. to about 70° C. or from about 40° C. to about 60° C.

In certain embodiments, the method is carried out in a chamber in which the pressure is reduced (i.e. lower than atmospheric pressure). In certain embodiments, the pressure in the chamber is equal to or less than about 1 bar or equal to or less than about 900 mbar (millibar) or equal to or less than about 800 mbar or equal to or less than about 700 mbar or equal to or less than about 600 mbar or equal to or less than about 500 mbar or equal to or less than about 400 mbar or equal to or less than about 300 mbar or equal to or less than about 200 mbar. In certain embodiments, the pressure inside the chamber is equal to or less than about 190 mbar or equal to or less than about 180 mbar or equal to or less than about 170 mbar or equal to or less than about 160 mbar or equal to or less than about 150 mbar or equal to or less than about 140 mbar or equal to or less than about 130 mbar or equal to or less than about 120 mbar or equal to or less than about 110 mbar or equal to or less than about 100 mbar. In certain embodiments, the pressure inside the chamber is equal to or less than about 90 mbar or equal to or less than about 80 mbar or equal to or less than about 70 mbar or equal to or less than about 60 mbar or equal to or less than about 50 mbar. In certain embodiments, the pressure inside the chamber ranges from about 10 mbar to about 200 mbar or from about 20 mbar to about 150 mbar or from about 30 mbar to about 120 mbar or from about 40 mbar to about 110 mbar or from about 50 mbar to about 100 mbar.

In certain embodiments, the pressure inside the chamber is equal to or less than about 200 mbar and the temperature of the organic liquid is equal to or greater than about 60° C. In certain embodiments, the pressure inside the chamber ranges from about 100 mbar to about 200 mbar and the temperature of the organic liquid ranges from about 60° C. to about 90° C.

In certain embodiments, the pressure inside the chamber is equal to or less than about 150 mbar and the temperature of the organic liquid is equal to or greater than about 50° C. In certain embodiments, the pressure inside the chamber ranges from about 50 mbar to about 150 mbar and the temperature of the organic liquid ranges from about 50° C. to about 80° C.

In certain embodiments, the organic liquid replaces the water in the ceramic green body. In this embodiment, the temperature of the organic liquid together with the pressure inside the container may not be sufficient to vaporize water in the ceramic green body. In this embodiment, the temperature of the organic liquid may be below the vaporization temperature of water. For example, the organic liquid may be at a temperature below about 25° C. or below about 20° C. For example, the organic liquid may be at a temperature ranging from about 10° C. to about 25° C. or from about 10° C. to about 20° C. or from about 15° C. to about 20° C. In these embodiments, the pressure inside the container may be lower than the pressure at which vaporization of water occurs. For example, the pressure inside the container may be about atmospheric pressure or from about 80 kPa to about 120 kPa, or from about 90 kPa to about 110 kPa or from about 95 kPa to about 105 kPa. In these embodiments, the organic liquid may, for example, have a vaporization temperature less than the vaporization temperature of water.

In certain embodiments, the organic liquid continuously flows into and out of the container in which the immersion step is being carried out. In other words, the organic liquid is in constant motion. This may, for example, maintain a water or water vapour pressure gradient to assist in removal of water vapour from the ceramic green body. The container in which the immersion step is carried out may therefore comprise one or more inlets and one or more outlets for respectively delivering and removing the organic liquid to/from the container. The organic liquid may, for example, be pumped into and out of the container, for example using a vacuum pump.

In certain embodiments, organic liquid is removed from the container during the immersion step and then re-introduced into the container. Alternatively or in addition, in certain embodiments, new organic liquid is introduced into the container. After removal from the container, the organic liquid may be separated from water that is removed from the ceramic green body. The organic liquid may, for example, be separated from water by decantation where the organic liquid is not miscible with water. After removal from the container, the organic liquid may be heated (e.g. re-heated) before it is re-introduced into the container. The organic liquid may, for example, be heated to the temperature at which it was originally introduced into the container. This may, for example, maintain a constant temperature or temperature range within the container during the immersion step.

The organic liquid may be any organic compound that is in the form of a liquid during the immersing step (i.e. any organic compound that is in the form of a liquid at the temperature and pressure under which the immersing step is carried out). In certain embodiments, the organic liquid is not miscible with water. In certain embodiments, the organic liquid comprises one or more branched-chain alkane(s) (isoparaffins). In certain embodiments, the organic liquid is Vossfin 2006, available from Solvadis Distribution GmbH. In certain embodiments, the organic liquid is miscible with water. In certain embodiments, the organic liquid is a C2-C5 ketone (a ketone having 2, 3, 4 or 5 carbon atoms) or a C1-C5 alcohol (an alcohol having 1, 2, 3, 4 or 5 carbon atoms). In certain embodiments, the organic liquid is acetone. In certain embodiments, the organic liquid is propanol (e.g. iso-propanol).

The organic liquid may, for example, have a boiling point equal to or greater than about 150° C. or equal to or greater than about 155° C. or equal to or greater than about 160° C. or equal to or greater than about 165° C. or equal to or greater than about 170° C. or equal to or greater than about 175° C. The organic liquid may, for example, have a boiling point equal to or less than about 250° C. or equal to or less than about 240° C. or equal to or less than about 230° C. or equal to or less than about 220° C. or equal to or less than about 210° C. or equal to or less than about 200° C. The organic liquid may, for example, have a boiling range from or within the range of from about 150° C. to about 250° C. or from about 150° C. to about 200° C. or from about 160° C. to about 200° C. or from about 170° C. to about 200° C. For example, the organic liquid may have a boiling range from or within the range of from about 175° C. to about 195° C.

The organic liquid may, for example, have a freezing point equal to or less than about −5° C. or equal to or less than about −10° C. or equal to or less than about −15° C. or equal to or less than about −16° C. or equal to or less than about −17° C. or equal to or less than about −18° C. or equal to or less than about −19° C. or equal to or less than about −20° C.

The organic liquid may, for example, have a density ranging from about 700 kg/m³ to about 800 kg/m³. For example, the organic liquid may have a density ranging from about 710 kg/m³ to about 290 kg/m³ or from about 720 kg/m³ to about 780 kg/m³ or from about 730 kg/m³ to about 770 kg/m³ or from about 740 kg/m³ to about 760 kg/m³ or from about 750 kg/m³ to about 760 kg/m³.

The organic liquid may, for example, have a flash point ranging from about 40° C. to about 70° C. or from about 45° C. to about 65° C. or from about 50° C. to about 60° C.

In certain embodiments, the ceramic green body is a honeycomb structure. The term “honeycomb structure” refers to structures having a plurality of cells (channels), for example of dimension ranging from 500 to 2000 microns, extending therethrough. The cells may, for example, have a round, circular, square, rectangular, octagonal, polygonal or other cross section. The cells may, for example, have a different cross section at the inlet and outlet ends of the honeycomb structure. The cells may, for example, extend in a longitudinal direction. The cells may, for example, be organized in a repeating pattern. The cells may, for example be separated by porous partitions. The cells may, for example, be plugged, for example alternatively plugged on the inlet and outlet side so that gas is forced through the porous ceramic wall between the cells. Optionally, the opening area at one end face of the honeycomb structure may be different from an opening area at the other end face thereof. For example, the honeycomb structure may have a group of large volume through-holes plugged so as to make a relatively large sum of opening areas on its gas inlet side and a group of small volume through-holes plugged so as to make a relatively small sum of opening areas on its gas outlet side. The honeycomb structure may, for example, be impregnated (e.g. with a catalyst). In certain embodiments, the cells of the honeycomb structure are arranged in accordance with the structures described in WO-A-2011/117385, the contents of which are incorporated herein by reference. When the ceramic green body is a honeycomb structure, the organic liquid may enter and/or flow through the cells of the ceramic honeycomb structure.

The ceramic green body may, for example, be placed on a perforated support inside the container (e.g. such that the cells of the honeycomb structure are in contact with the perforated support). Where the ceramic green body is a ceramic honeycomb structure, the perforated structure may, for example, assist in allowing the organic liquid to flow through the cells of the honeycomb structure.

The immersion step may, for example, be performed for at least about 30 minutes. For example, the immersion step may be performed for at least about 25 minutes or at least about 40 minutes or at least about 45 minutes or at least about 50 minutes. For example, the immersion step may be performed for up to about 120 minutes or up to about 100 minutes or up to about 80 minutes or up to about 60 minutes. For example, the immersion step may be performed for about 30 minutes to about 2 hours. For example, the immersion step may be performed for about 45 minutes to about 1.5 hours (1 hour 30 minutes).

After the immersion step, the organic liquid and vaporized water is removed from the container, for example such that the container is substantially free of organic liquid and vaporized water. For example, at least about 97 wt % or at least about 98 wt % or at least about 99 wt % of the organic liquid may be removed from the container. For example, a vacuum pump may be used to remove the organic liquid and vaporized water from the container, for example until no further material can be removed. In certain embodiments, the maximum quantity of liquid is evacuated from the chamber using a vacuum pump.

After the step of removing the organic liquid and vaporized water from the container, any residual organic liquid and water in the container and ceramic green body may then be removed. The residual organic liquid in the container may be equal to or less than about 3 wt % of the organic liquid used for the immersion step, for example equal to or less than about 2 wt % or equal to or less than about 1 wt % of the organic liquid used in the immersion step. The residual water in the ceramic green body may, for example, be equal to or less than about 30 wt % or equal to or less than about 20 wt % or equal to or less than about 10 wt % or equal to 9 wt % or equal to or less than about 8 wt % or equal to or less than about 7 wt % or equal to or less than about 6 wt % or equal to or less than about 5 wt % or equal to or less than about 4 wt % or equal to or less than about 3 wt % or equal to or less than about 2 wt % or equal to or less than about 1 wt % of the water present in the ceramic green body before the immersion step.

The residual organic liquid and water may, for example, be removed by reducing the pressure and/or increasing the temperature inside the container (after the organic liquid and vaporized water is removed).

For example, the pressure inside the container may be equal to or less than about 10 mbar or equal to or less than about 9 mbar or equal to or less than about 8 mbar or equal to or less than about 7 mbar or equal to or less than about 6 mbar or equal to or less than about 5 mbar or equal to or less than about 4 mbar.

For example, the temperature inside the container may be equal to or greater than about 80° C. or equal to or greater than about 85° C. or equal to or greater than about 90° C. or equal to or greater than about 95° C. or equal to or greater than about 100° C. or equal to or greater than about 105° C. or equal to or greater than about 110° C. The temperature inside the container may be altered by introducing a solvent vapour into the container. The temperature of the solvent vapour may be equal to or greater than about 80° C. or equal to or greater than about 85° C. or equal to or greater than about 90° C. or equal to or greater than about 95° C. or equal to or greater than about 100° C. or equal to or greater than about 105° C. or equal to or greater than about 110° C. The solvent may, for example, be continuously delivered to and removed from the container during this step.

The step of further increasing temperature and decreasing pressure (e.g. using hot solvent vapour) causes water to begin to vaporize and to be removed from the container. This may cause the pressure inside the container to decrease. The increase in temperature and decrease in pressure (e.g. using hot solvent vapour) may, for example, be maintained until the pressure inside the container stabilizes (stops decreasing).

The solvent used may, for example, be the same solvent that was used for the immersion step. For example, the solvent may be any organic compound that is in the form of a vapour under the temperature and pressure at which the hot solvent vapour step is performed. For example, the solvent may not be miscible with water. In certain embodiments, the solvent comprises one or more branched-chain alkane(s) (isoparaffins). In certain embodiments, the solvent is Vossfin 2006, available from Solvadis Distribution GmbH.

After the drying process, the dried ceramic green body may be sintered by a process known by a person skilled in the art.

In certain embodiments, the ceramic green body comprises a binder. The binder may, for example, be a cellulose binder. The binder may, for example, be a methyl cellulose binder (e.g. Methocel™ K15M or Methocel™ K15MS or Methocel™ K4 or Methocel™ K100) or an ethyl cellulose binder or a methyl ethyl cellulose binder. In certain embodiments, the organic liquid and/or the drying process increases the gelification of the binder in the ceramic green body.

### Extrusion Method

There is further provided herein a method for extruding a ceramic composition, the method comprising differentially controlling the temperature of different regions of the ceramic composition prior to and/or during extrusion. The different regions of the ceramic composition may thus each have a different temperature and the ceramic composition may not have a uniform temperature throughout.

There is also provided herein a device for differentially controlling the temperature of a ceramic composition (e.g. various regions of a ceramic composition). The device interacts with the ceramic composition and comprises regions in which temperature can be independently controlled.

Without wishing to be bound by theory, it is believed that the shape and/or dimensions of an extrusion die may affect the flow rate of a ceramic composition through the die, and consequently affect the shape of the extruded composition. For example, the shear stress applied on the ceramic composition (e.g. paste) by the compression screws of the extruder change (e.g. increase) the temperature of the paste. This may, for example, create a zone on the die which has a different (e.g. higher) flow of paste, thus producing deformation of the extruded composition. For example, it is believed that non-uniform flow of a ceramic composition through an extrusion die for making a ceramic honeycomb structure may result in bowing of the extruded honeycomb structure. The present inventors have surprisingly found that the flow of a ceramic composition can be controlled by varying the temperature of the ceramic composition. Thus, flow of different regions of a ceramic composition can be controlled by varying the temperature of each region. For example, the different regions of a ceramic material may have the same or similar (e.g. within 0.5° C.) temperatures in order to achieve uniform flow rate through an extrusion die. For example, the different regions of a ceramic material may have different temperatures in order to achieve uniform flow rate through an extrusion die. Thus, there is provided herein a method for reducing bowing of a ceramic honeycomb structure.

The different regions of the ceramic composition refer to different locations within the ceramic composition. The different regions of the ceramic composition may, for example, be defined in terms of the cross sectional area of the ceramic composition that is extruded through the die or in relation to the periphery of the extrusion die or device for controlling the temperature of the ceramic composition. For example, where the extrusion die produces an article with a circular cross-section, the different regions of the ceramic composition may be defined as segments of a circle.

The temperature of the different regions of the ceramic composition is not discrete (separate and distinct) in comparison to other regions of the ceramic composition and may not be the same throughout one region. Rather, a temperature gradient may form within each region and/or between the different regions.

The ceramic composition has at least two regions in which the average and/or highest temperature is different. For example, the ceramic composition may have at least three or at least four or at least five or at least six or at least seven or at least eight or at least nine or at least ten regions in which the average and/or highest temperature is different. Where the ceramic composition has more than two regions in which the temperature is different, the average and/or highest temperature in each region is different to the respective average and/or highest temperature in neighbouring regions (regions in which it is in contact), but may or may not be the same as the average and/or highest temperature in non-neighbouring regions.

The difference between the highest and/or average temperature of each region may, for example, be at least about 0.1° C. or at least about 0.2° C. or at least about 0.3° C. or at least about 0.4° C. or at least about 0.5° C. For example, the difference between the highest and/or average temperature of each region may be up to about 10° C. or up to about 9° C. or up to about 8° C. or up to about 7° C. or up to about 6° C. or up to about 5° C. or up to about 4° C. or up to about 3° C. or up to about 2.5° C. or up to about 2° C. or up to about 1.5° C. or up to about 1° C. For example, the difference between the average and/or highest temperature of each region may range from about 0.1° C. to about 10° C. or from about 0.1° C. to about 5° C. or from about 0.1° C. to about 3° C. or from about 0.1° C. to about 2° C. or from about 0.1° C. to about 1.5° C.

The ceramic composition may, for example, interact with a device that can alter the temperature of the ceramic composition immediately before extrusion (i.e. as the last step before extrusion). For example, the ceramic composition may be pushed through the device that can alter its temperature. The device may or may not have the same cross-section as the extrusion die. For example, the temperature of the different regions of the ceramic composition may be controlled or set prior to extrusion such that the temperature difference (and consequently the flow rate of each region) is maintained during extrusion.

Alternatively or additionally, the ceramic composition may interact with a device that can alter the temperature of the ceramic composition during extrusion. For example, the device may be integrated with the extrusion die. For example, the temperature of the different regions of the ceramic composition may be controlled or set during extrusion.

The term interact means that the device has an effect on the ceramic composition. The device may or may not be in direct contact with the ceramic composition. The device may, for example, be in direct contact or interact with the extrusion die.

In certain embodiments, the temperature of different regions of the ceramic composition is controlled by different regions of the device that can be independently controlled. For example, the temperature of different regions of the ceramic composition may be controlled by controlling the temperature of different regions of the device. Controlling the temperature of different regions of a device may, for example, consequently control the temperature of regions of the ceramic composition that interact (e.g. are in contact with) the respective regions of the device.

The device may, for example, comprise a hollow cross-section through which the ceramic composition is pushed. For example, the device may have the same cross-section as the extrusion die. For example, the device may be integrated with the extrusion die. The device may or may not be in direct physical contact with the ceramic composition. For example, the device may be in contact with another component or device of the extrusion equipment (e.g. the extrusion die), which may directly contact the ceramic composition.

In certain embodiments, the device has the same cross-section outline as the extrusion die. For example, where the extrusion die is for forming a honeycomb structure, the device has a round or circular cross-section. In certain embodiments, the different regions of the device in which temperature is independently controlled are distributed around the periphery of the device. For example, where the device is round or circular, the different regions of the device in which temperature is independently controlled are distributed around the circumference of the cross-section (circumference of the circle). The regions in which temperature may be independently controlled may be the same or different in size. For example, where the device is circular, the circumferential sections of the circle may be the same or different sizes. The regions may, for example, be evenly distributed. The regions may, for example, be continuous or may be spaced apart (e.g. at regular or irregular intervals).

The device may, for example, comprise at least 2 regions in which temperature can be independently controlled. For example, the device may comprise at least 3 or at least 4 or at least 5 or at least 6 or at least 7 or at least 8 or at least 9 or at least 10 regions in which temperature can be independently controlled. The device may, for example, comprise up to about 50 or up to about 45 or up to about 40 or up to about 35 or up to about 30 or up to about 25 or up to about 20 or up to about 15 regions in which temperature can be independently controlled. In certain embodiments, the temperature of the regions themselves may, for example, be independently controlled.

During use, the temperature may not be controlled in every region in which temperature may be independently controlled. For example, during use, the temperature of 1 region of a total 2 or 3 or 4 or 5 or 6 or 7 or 8 or 9 or 10 or more regions in which temperature can be independently controlled, is actually controlled. For example, the temperature of 2 regions of a total 2 or 3 or 4 or 5 or 6 or 7 or 8 or 9 or 10 or more regions in which temperature can be independently controlled, is controlled during use. For example, the temperature of 3 regions of a total 2 or 3 or 4 or 5 or 6 or 7 or 8 or 9 or 10 or more regions in which temperature can be independently controlled, is controlled during use. For example, the temperature of 4, 5, 6, 7, 8, 9 or 10 regions of a total 2 or 3 or 4 or 5 or 6 or 7 or 8 or 9 or 10 or more regions in which temperature can be independently controlled, is controlled during use.

Each region of the device may, for example, comprise an inlet and an outlet for supplying a fluid to or removing a fluid from the region (e.g. independently of the other regions). The fluid may, for example, be a heating fluid or cooling fluid to respectively heat or cool the region of the device. The heating fluid may, for example, have a temperature above the temperature of the ceramic composition. This may heat the respective regions of the ceramic composition. The cooling fluid may, for example, have a temperature below the temperature of the ceramic composition. This may consequently heat or cool the respective region of the ceramic composition. The temperature of the heating or cooling fluid may, for example, be set based on the desired change in temperature for the ceramic composition. The flow rate of the heating or cooling fluid into the different regions of the device may, for example, be set based on the desired temperature for the different regions of the ceramic composition. The flow rate of the heating or cooling fluid into the different regions of the device may, for example, independently be on (e.g. at different or the same flow rates) or off.

The fluid may, for example, be a liquid or gas. The fluid may, for example, be water. The fluid may, for example, be any coolant that may commonly be used in cooling systems such as refrigerators, in cars or industrial machines. For example, the fluid may comprise water, antifreeze, ethylene glycol, diethylene glycol, propylene glycol, polyalkylene glycol, betaine, mineral oils, castor oil, silicone oils, fluorocarbon oils, transformer oil, halomethanes (e.g. R-12, R-22), liquefied propane, haloalkanes, ammonia (e.g. anhydrous ammonia), sulphur dioxide, carbon dioxide (e.g. liquid carbon dioxide), nitrogen (e.g. liquid nitrogen), hydrogen (e.g. liquid hydrogen) or any combination thereof.

Examples of the device and the temperatures that the different regions of the external part of the device may reach are shown in FIGS. 6 to 8.

The temperature of the fluid may, for example, range from about 10° C. to about 20° C. For example, the temperature of the fluid may range from about 11° C. to about 19° C. or from about 12° C. to about 18° C. or from about 13° C. to about 17° C. or from about 14° C. to about 16° C. For example, the temperature of the fluid may range from about 10° C. to about 16° C. or from about 10° C. to about 15° C.

The difference in temperature between the fluid and the corresponding external section of the device may, for example, range from about 2° C. to about 8° C. For example, the difference in temperature between the fluid and the external section of the device may range from about 2.5° C. to about 7.5° C. or from about 3° C. to about 7° C. or from about 4° C. to about 6° C.

The difference in temperature between the heating or cooling fluid and the ceramic composition may, for example, range from about 2° C. to about 8° C. For example, the difference in temperature between the heating or cooling fluid and the ceramic composition may range from about 2.5° C. to about 7.5° C. or from about 3° C. to about 7° C. or from about 4° C. to about 6° C.

Each region of the device may comprise one or more temperature sensors. The temperature sensor may be linked to a feedback unit to inform an operator of the temperature of the respective regions of the device. Alternatively or additionally, the temperature sensors may be able to inform an operator of the temperature of the regions of the ceramic composition.

The presence of one or more binders in the ceramic composition may enable the flow rate of the ceramic composition to be affected by temperature. Thus, in certain embodiments, the ceramic composition comprises a binder. The binder may, for example, be a binder that is particularly sensitive to temperature. The binder may, for example, be a binder that has different viscosities at different temperatures.

For example, the difference in temperature at which the binder has minimum viscosity and the temperature at which the binder has maximum viscosity may be equal to or less than about 10° C. For example, the difference in temperature at which the binder has minimum viscosity and the temperature at which the binder has maximum viscosity may be equal to or less than about 9° C. or equal to or less than about 8° C. or equal to or less than about 7° C. or equal to or less than about 6° C. or equal to or less than about 5° C. or equal to or less than about 4° C. For example, the difference in temperature at which the binder has minimum viscosity and the temperature at which the binder has maximum viscosity may be equal to or greater than about 1° C. or equal to or greater than about 2° C. or equal to or greater than about 3° C.

The binder may, for example, be a cellulose binder. The binder may, for example, be a methyl cellulose binder (e.g. Methocel™ K15M or Methocel™ K15MS or Methocel™ K4 or Methocel™ K100) or an ethyl cellulose binder or a methyl ethyl cellulose binder.

The ceramic composition to be extruded may be formed of any suitable ceramic material. In certain embodiments, the ceramic composition may comprise one or more of aluminosilicate precursors, silicon carbide (SiC), silicon nitride, mullite, cordierite, zirconia, zirconia precursors, titania, silica, magnesia, alumina, spinel, tialite, tialite precursors, kyanite, sillimanite, andalusite, lithium aluminium silicate, aluminium titanate and mixtures thereof. The ceramic material may contain metals, such as magnesium, Fe—Cr—Al based metal, metal silicon and the like. Tialite precursors include, for example TiO₂, for example anatase and/or rutile. Aluminosilicate precursors include, for example, mullite precursors such as andalusite. Zirconia precursors include, for example, zirconium oxide (e.g. fused zirconium oxide). Magnesium precursors include, for example, magnesium carbonate.

The extrusion methods disclosed herein may, for example, adjust the temperature of different regions of the ceramic composition in order to obtain substantially uniform flow of the ceramic composition during extrusion. For example, the temperature of regions of the ceramic composition in which flow rate is higher than average may be decreased to decrease the flow rate and/or the temperature of regions of the ceramic composition in which flow rate is lower may be increased to increase the flow rate. This may, for example, reduce or inhibit deformation and/or bowing of the ceramic composition (e.g. ceramic honeycomb structure).

However, in other embodiments, deformation or bowing of an extruded ceramic composition (e.g. ceramic honeycomb structure) may be desirable. In these embodiments, the temperature of different regions of the ceramic composition may be adjusted in order to obtain a different flow rate in different regions.

The deformation (e.g. bowing) of the extruded ceramic composition may be monitored to determine the effect of different temperatures in different regions on the extruded composition. For example, deformation may be monitored visually or may be monitored using optical sensors.

The extruded ceramic article may then, for example, be dried and/or sintered using methods known to those skilled in the art or the methods described herein.

### Plugging Method and Composition

There is also provided herein a composition for plugging one or more cells of a ceramic honeycomb structure and the use of the plugging composition to fill an opening of one or more cells of the ceramic honeycomb structure. There is further provided herein plugged ceramic honeycomb structures or articles (prior to and after sintering).

The term “honeycomb structure” refers to structures having a plurality of cells (channels), for example of dimension ranging from 500 to 2000 microns, extending therethrough. The cells may, for example, have a round, circular, square, rectangular, octagonal, polygonal or other cross section. The cells may, for example, have a different cross section at the inlet and outlet ends of the honeycomb structure. The cells may, for example, extend in a longitudinal direction. The cells may, for example, be organized in a repeating pattern. The cells may, for example be separated by porous partitions. Optionally, the opening area at one end face of the honeycomb structure may be different from an opening area at the other end face thereof. For example, the honeycomb structure may have a group of large volume through-holes plugged so as to make a relatively large sum of opening areas on its gas inlet side and a group of small volume through-holes plugged so as to make a relatively small sum of opening areas on its gas outlet side. The honeycomb structure may, for example, be impregnated (e.g. with a catalyst).

In the manufacture of particulate filters using ceramic honeycomb structures, one or more cells of the ceramic honeycomb structure are plugged. For example, the cells of the ceramic honeycomb structure may be alternatively plugged on the inlet and outlet sides so that gas is forced through the porous ceramic wall between the cells. In certain embodiments, the cells of the honeycomb structure are arranged in accordance with the structures described in WO-A-2011/117385, the contents of which are incorporated herein by reference. The term “plugged” means that the opening of the cell of the honeycomb structure is filled in order to prevent the passage of gas therethrough.

The ceramic honeycomb structure may, for example, be sintered before or at the same time its cells are plugged. Where the ceramic honeycomb structure is sintered before its cells are plugged, a second sintering step is required to sinter the plugging composition. It is therefore preferable to sinter the ceramic honeycomb structure and the plugging composition at the same time.

One common problem in manufacturing plugged ceramic honeycomb structures is that shrinkage of the ceramic honeycomb structure and the plugging composition after sintering is often different and/or occurs at a different rate, thus resulting in deformation and/or leakage of the plugged cells. If sintering shrinkage of the ceramic honeycomb structure is lower than the sintering shrinkage of the plugging composition, there may be spaces around the plugging composition, resulting in leakage. On the other hand, if sintering shrinkage of the ceramic honeycomb structure is higher than the sintering shrinkage of the plugging composition, there may be deformation of the ceramic honeycomb structure and/or the plugging composition, which may also result in leakage. The present inventors have surprisingly found that plugging compositions that have a sintering shrinkage that is the same or up to about 0.2 percentage points less than the sintering shrinkage of the ceramic honeycomb structure (e.g. median of sintering shrinkage of faces of ceramic honeycomb structure) that they are to be used in (to plug cells thereof) overcome this problem by providing improved or acceptable leakage and deformation.

Sintering shrinkage is measured using a machine to measure the dimensions (e.g. diameter) of the plugging composition and/or honeycomb structure parts before and after sintering and calculating the difference in the measured dimensions. For example, the shrinkage of each face of the ceramic honeycomb structure and the middle of the ceramic honeycomb structure (i.e. the middle of the longitudinal axis of the honeycomb) may be measured. For example, the median of the sintering shrinkage of the faces of the honeycomb structure may be determined and compared to the sintering shrinkage of a small block of plugging paste (e.g. 19 mm×13 mm×11.5 mm). Different samples of each composition may be measured (e.g. 5 per composition) and the median sintering shrinkage calculated. The plugging composition may, for example, have a sintering shrinkage that is equal to or up to about 0.15 percentage points less than the sintering shrinkage of the ceramic honeycomb structure (e.g. median of sintering shrinkage of faces of ceramic honeycomb structure), for example equal to or up to about 0.1 percentage points less than the sintering shrinkage of the ceramic honeycomb structure (e.g. median of sintering shrinkage of faces of ceramic honeycomb structure), for example equal to or up to about 0.05 percentage points less than the sintering shrinkage of the ceramic honeycomb structure (e.g. median of sintering shrinkage of faces of ceramic honeycomb structure).

In certain embodiments, the plugging composition has a sintering shrinkage ranging from about 8.2% to about 8.4%. For example, the plugging composition may have a sintering shrinkage range from about 8.25% to about 8.35% or from about 8.3% to about 8.4%.

In certain embodiments, the ceramic honeycomb structure (e.g. median of sintering shrinkage of faces of ceramic honeycomb structure) has a sintering shrinkage ranging from about 8.4% to about 8.6%. For example, the ceramic honeycomb structure may have a sintering shrinkage ranging from about 8.45% to about 8.55% or from about 8.5% to about 8.6%.

In certain embodiments, the particle size distribution of the mineral component of the plugging composition is altered in comparison to the particle size distribution of the mineral component of the ceramic honeycomb structure in order to obtain a more similar sintering shrinkage. In certain embodiments, the particle size distribution of only one mineral of the mineral component of the plugging composition is altered. In certain embodiments, the particle size distributions of all minerals of the mineral component (i.e. particle size distribution of the entire mineral component) of the plugging composition is/are altered.

In certain embodiments, the plugging composition comprises a mineral component that has a narrower particle size distribution that the particle size distribution of the mineral component of the ceramic honeycomb structure. This means that the difference between the maximum particle size and minimum particle size of the mineral component of the plugging composition is smaller than the difference between the maximum particle size and minimum particle size of the mineral component of the ceramic honeycomb structure. In certain embodiments, the maximum particle size maybe defined by d₉₀ and the minimum particle size may be defined by d₁₀.

For example, the difference between the maximum particle size and minimum particle size of the mineral component of the plugging composition may be at least about 20 μm or at least about 25 μm or at least about 30 μm or at least about 35 μm less than the difference between the maximum particle size and minimum particle size of the mineral component of the ceramic honeycomb structure. For example, the difference between the maximum particle size and minimum particle size of the plugging composition may be up to about 60 μm or up to about 55 μm or up to about 50 μm or up to about 45 μm or up to about 40 μm less than the difference between the maximum particle size and minimum particle size of the mineral component of the ceramic honeycomb structure.

In certain embodiments, the mineral component of the plugging composition has a steeper particle size distribution than the mineral component of the ceramic honeycomb structure. The steepness of the mineral component is defined as (d₃₀/d₇₀×100). For example, the mineral component of the plugging composition may have a steepness that is at least about 5 units or at least about 10 units or at least about 15 units or at least about 20 units or at least about 25 units of at least about 30 units or at least about 35 units or at least about 40 units greater than the steepness of the mineral component of the ceramic honeycomb structure. For example, the mineral component of the plugging composition may have a steepness that is up to about 80 units or up to about 75 units or up to about 70 units or up to about 65 units or up to about 60 units or up to about 55 units or up to about 50 units greater than the steepness of the mineral component of the ceramic honeycomb structure.

In certain embodiments, the mineral component of the plugging composition has a smaller d₅₀ than the mineral component of the ceramic honeycomb structure. For example, the plugging composition may have a d₅₀ that is at least about 5 μm or at least about 10 μm or at least about 15 μm or at least about 20 μm or at least about 25 μm or at least about 30 μm or at least about 35 μm or at least about 40 μm lower than the d₅₀ of the mineral component of the ceramic honeycomb structure.

In certain embodiments, the mineral component of the plugging composition has a larger d₁₀ than the mineral component of the ceramic honeycomb structure. For example, the plugging composition may have a d₁₀ that is at least about 1 μm or at least about 2 μm or at least about 3 μm or at least about 4 μm or at least about 5 μm or at least about 6 μm or at least about 7 μm or at least about 8 μm or at least about 9 μm or at least about 10 μm larger than the d₁₀ of the mineral component of the ceramic honeycomb structure. For example, the plugging composition may have a d₁₀ that is up to about 20 μm or up to about 15 μm or up to about 10 μm larger than the d₁₀ of the mineral component of the ceramic honeycomb structure.

In certain embodiments, the mineral component of the plugging composition has a d₉₀ that is smaller than the d₉₀ of the mineral component of the ceramic honeycomb structure. For example, the plugging composition may have a d₉₀ that is at least about 5 μm or at least about 10 μm or at least about 15 μm or at least about 20 μm or at least about 25 μm or at least about 30 μm or at least about 35 μm or at least about 40 μm smaller than the d₉₀ of the mineral component of the ceramic honeycomb structure. For example, the plugging composition may have a d₉₀ that is up to about 80 μm or up to about 70 μm or up to about 60 μm larger than the d₉₀ of the mineral component of the ceramic honeycomb structure.

Unless otherwise stated, the particle size properties referred to herein for the mineral starting material are as measured by the well-known conventional method employed in the art of laser light scattering, using a Malvern Mastersizer S machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value. The d₁₀ and d₉₀ are to be understood in similar fashion. The particle size of the ceramic honeycomb structure relates to the particle size of the composition that forms the ceramic honeycomb structure prior to sintering (i.e. before particles are fused due to sintering).

In certain embodiments, the minerals present in the plugging composition (i.e. types of minerals such as alumina, titania precursor etc.) are identical to the minerals present in the ceramic honeycomb structure. In certain embodiments, the quantity of each mineral and/or the relative proportions of each mineral in the plugging composition is identical to that of the ceramic honeycomb structure.

The plugging composition and the ceramic honeycomb structure may be formed of any suitable ceramic material. In certain embodiments, the plugging composition and/or the ceramic honeycomb structure may comprise one or more of aluminosilicate precursors, silicon carbide (SiC), silicon nitride, mullite, cordierite, zirconia, zirconia precursors, titania, silica, magnesia, alumina, spinel, tialite, tialite precursors, kyanite, sillimanite, andalusite, lithium aluminium silicate, aluminium titanate and mixtures thereof. The ceramic material may contain metals, such as magnesium, Fe—Cr—Al based metal, metal silicon and the like. Tialite precursors include, for example TiO₂, for example anatase and/or rutile. Aluminosilicate precursors include, for example, mullite precursors such as andalusite. Zirconia precursors include, for example, zirconium oxide (e.g. fused zirconium oxide). Magnesium precursors include, for example, magnesium carbonate. In certain embodiments, the mineral component of the plugging composition and/or the mineral component of the ceramic honeycomb structure comprises one or more aluminosilicate precursor(s) or aluminosilicate(s), one or more tialite precursor(s) or tialite, and one or more alumina precursor(s) or alumina. In certain embodiments, the ceramic honeycomb structure and/or the plugging composition further comprises one or more zirconia precursor(s) and/or one or more sources of magnesium.

In certain embodiments, the mineral component of the ceramic honeycomb structure and/or the plugging composition comprises from about 26 wt % to about 31 wt % total tialite and tialite precursor(s). In certain embodiments, the mineral component of the ceramic honeycomb structure and/or the plugging composition comprises from about 26.5 wt % to about 30.5 wt % or from about 27 wt % to about 30 wt % or from about 27.5 wt % to about 29.5 wt % or from about 28 wt % to about 29 wt % total tialite and tialite precursor(s).

In certain embodiments, the mineral component of the plugging composition comprises from about 19 wt % to about 21.5 wt % of tialite or a tialite precursor having a d₅₀ of less than 1 μm. In certain embodiments, the mineral component of the plugging composition comprises from about 19.5 wt % to about 21 wt % or from about 20 wt % to about 21 wt % of tialite or a tialite precursor having a d₅₀ of less than 1 μm. In certain embodiments, the tialite precursor is TiO₂ (e.g. anatase).

In certain embodiments, the mineral component of the plugging composition comprises from about 7 wt % to about 9.5 wt % of tialite or a tialite precursor having a d₅₀ ranging from about 15 μm to about 20 μm. In certain embodiments, the mineral component of the plugging composition comprises from about 7.5 wt % to about 9 wt % or from about 8 wt % to about 9 wt % of tialite or a tialite precursor having a d₅₀ ranging from about 15 μm to about 20 μm. In certain embodiments, the tialite precursor is TiO₂ (e.g. rutile).

In certain embodiments, the mineral component of the ceramic honeycomb structure comprises from about 26 wt % to about 31 wt % of tialite or a tialite precursor having a d₅₀ of less than 1 μm. For example, the mineral component of the ceramic honeycomb structure may comprise from about 26.5 wt % to about 30.5 wt % or from about 27 wt5 to about 30 wt % or from about 27.5 wt % to about 29.5 wt % or from about 28 wt % to about 29 wt % of tialite or a tialite precursor having a d₅₀ of less than 1 μm. In certain embodiments, the tialite precursor is TiO₂.

In certain embodiments, the mineral component of the ceramic honeycomb structure and/or the plugging composition comprises from about 23 wt % to about 26 wt % of one or more aluminosilicate(s) or aluminosilicate precursor(s). For example, the mineral component of the ceramic honeycomb structure and/or the plugging composition may comprise from about 23.5 wt % to about 25.5 wt % or from about 24 wt % to about 25 wt % of one or more aluminosilicate(s) or aluminosilicate precursor(s). In certain embodiments, one of the aluminosilicate precursors is a mullite precursor. In certain embodiments the mullite precursor is andalusite. In certain embodiments, the one or more aluminosilicate(s) or aluminosilicate precursor(s) have a d₅₀ ranging from about 30 μm to about 45 μm, for example from about 35 μm to about 40 μm.

In certain embodiments, the mineral component of the ceramic honeycomb structure and/or the plugging composition comprises from about 40 wt % to about 45 wt % alumina. For example, the mineral component of the ceramic honeycomb structure and/or the plugging composition may comprise from about 41 wt % to about 44 wt % or from about 42 wt % to about 43 wt % alumina.

In certain embodiments, the mineral component of the plugging composition comprises from about 23 wt % to about 28 wt % of an alumina having a d₅₀ ranging from about 2 μm to about 4 μm. For example, the mineral component of the plugging composition may comprise from about 23.5 wt % to about 27.5 wt % or from about 24 wt % to about 27 wt % or from about 24.5 wt % to about 26.5 wt % or from about 25 wt % to about 26 wt % of an alumina having a d₅₀ ranging from about 2 μm to about 4 μm.

In certain embodiments, the mineral component of the plugging composition comprises from about 15 wt % to about 20 wt % of an alumina having a d₅₀ ranging from about 25 μm to about 35 μm. For example, the mineral component of the plugging composition may comprise from about 15.5 wt % to about 19.5 wt % or from about 16 wt % to about 19 wt % or from about 16.5 wt % to about 18.5 wt % or from about 17 wt % to about 18 wt % of an alumina having a d₅₀ ranging from about 25 μm to about 35 μm.

In certain embodiments, the mineral component of the ceramic honeycomb structure comprises from about 32 wt % to about 38 wt % of an alumina having a d₅₀ ranging from about 75 μm to about 80 μm. For example, the mineral component of the ceramic honeycomb structure may comprise from about 32.5 wt % to about 37.5 wt % or from about 33 wt % to about 37 wt % or from about 33.5 wt % to about 36.5 wt % or from about 34 wt % to about 36 wt % or from about 35 wt % to about 36 wt % of an alumina having a d₅₀ ranging from about 75 μm to about 80 μm.

In certain embodiments, the mineral composition of the ceramic honeycomb structure and/or the plugging composition comprises from about 0 wt % to about 5 wt % of zirconia and/or a zirconia precursor. For example, the mineral composition of the ceramic honeycomb structure and/or the plugging composition may comprise from about 0.5 wt % to about 4.5 wt % or from about 1 wt % to about 4 wt % or from about 1.5 wt % to about 3.5 wt % or from about 2 wt % to about 3 wt % of zirconia and/or a zirconia precursor. In certain embodiments, the zirconia precursor is zirconium oxide.

In certain embodiments, the mineral composition of the ceramic honeycomb structure and/or the plugging composition comprises from about 0 wt % to about 3 wt % of magnesium or a magnesium source. For example, the mineral composition of the ceramic honeycomb structure and/or the plugging composition may comprise from about 0.5 wt % to about 2.5 wt % or from about 1 wt % to about 2 wt % of magnesium or a magnesium source. In certain embodiments, the magnesium source is magnesium carbonate.

In certain embodiments, the mineral component of the ceramic honeycomb structure and/or the plugging composition comprises:
from about 26 wt % to about 31 wt % of tialite and/or one or more tialite precursors;
from about 23 wt % to about 26 wt % of aluminosilicate and/or one or more aluminosilicate precursors;
from about 40 wt % to about 45 wt % alumina;
from about 0 wt % to about 5 wt % zirconia or one or more zirconia precursors;
from about 0 wt % to about 3 wt % magnesium or one or more magnesium precursor.

In certain embodiments, the mineral component of the plugging composition comprises:
from about 19 wt % to about 21.5 wt % of tialite or tialite precursor having a d₅₀ of less than 1 μm;
from about 7 wt % to about 9.5 wt % of tialite or tialite precursor having a d₅₀ ranging from about 15 μm to about 20 μm;
from about 40 wt % to about 45 wt % of an aluminosilicate or aluminosilicate precursor having a d₅₀ ranging from about 30 μm to about 45 μm;
from about 15 wt % to about 20 wt % of an alumina having a d₅₀ ranging from about 25 μm to about 35 μm;
from about 23 wt % to about 28 wt % of an alumina having a d₅₀ ranging from about 2 μm to about 4 μm;
from about 0 wt % to about 5 wt % zirconia or one or more zirconia precursors;
from about 0 wt % to about 3 wt % magnesium or one or more magnesium precursor.

In certain embodiments, the mineral component of the ceramic honeycomb structure comprises:
from about 26 wt % to about 31 wt % of tialite or a tialite precursor having a d₅₀ of less than 1 μm;
from about 40 wt % to about 45 wt % of an aluminosilicate or aluminosilicate precursor having a d₅₀ ranging from about 30 μm to about 45 μm;
32 wt % to about 38 wt % of an alumina having a d₅₀ ranging from about 75 μm to about 80 μm;
from about 0 wt % to about 5 wt % zirconia or one or more zirconia precursors;
from about 0 wt % to about 3 wt % magnesium or one or more magnesium precursor.

The ceramic honeycomb structure and/or the plugging composition may comprise one or more binding agents; the function of the binding agent is to provide a sufficient mechanical stability before the heating or sintering step. Suitable binding agents may be selected from the group consisting of methyl cellulose, hydroxymethylpropyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, alginates and mixtures thereof. The binding agents can be present in a total amount between 1.5% and 15% by weight, or between 2% and 9% by weight (based on the dry weight of the ceramic honeycomb structure and/or plugging composition).

The ceramic honeycomb structure and/or the plugging composition may comprise one or more mineral binders; suitable mineral binder may be selected from the group including, but not limited to, silica, bentonite, aluminum phosphate, boehmite, sodium silicates, boron silicates and mixtures thereof.

In certain embodiments, the plugging composition comprises a starch binder. The plugging composition may, for example, comprise from about 4 wt % to about 9 wt % of the starch binder, for example from about 4.5 wt % to about 7.5 wt % or from about 5 wt % to about 7 wt % or from about 5.5 wt % to about 6.5 wt % of the starch binder.

The ceramic honeycomb structure and/or the plugging composition may comprise one or more auxiliants, which provide the raw material with advantageous properties for the extrusion step (plasticizers, glidants, lubricants, deflocculants and the like). Suitable auxiliants may be selected from the groups consisting of polyethylene glycols (PEGs), glycerol, ethylene glycol, octyl phthalates, ammonium stearates, wax emulsions, oleic acid, Manhattan fish oil, stearic acid, wax, palmitic acid, linoleic acid, myristic acid, lauric acid and mixtures thereof. The ceramic honeycomb structure may, for example, comprise one or more porous agents. The auxiliants can be present in a total amount between 0.5% or 1.5% and 15% by weight, or between 2% and 9% by weight (based on the dry weight of the ceramic honeycomb structure and/or the plugging composition; if liquid auxiliants are used, the weight is included into the dry weight of the ceramic honeycomb structure and/or the plugging composition). The “dry weight” of the ceramic honeycomb structure and/or the plugging composition refers to the total weight of any compounds discussed herein to be suitable to be used in the extrudable mixture, i.e., the total weight of the mineral phases and of the binders/auxiliants. The “dry weight” is thus understood to include such auxiliants that are liquid under ambient conditions, but it does not include water in aqueous solutions of minerals, binders or auxiliants if such are used to prepare the mixture.

In certain embodiments, the plugging composition comprise deflocculant. For example, the plugging composition may comprise from about 0.1 wt % to about 0.5 wt % of the deflocculant. For example, the plugging composition may comprise from about 0.25 wt % to about 0.45 wt % or from about 0.3 wt % to about 0.4 wt % of the deflocculant.

In certain embodiments, the plugging composition comprises thermally expanding microspheres (small particles that increase in diameter upon heating). For example, the thermally expanding microspheres may be Expancel® microspheres available from Akzo Nobel. These microspheres are spherical plastic particles that encapsulate a gas. The gas expands upon heating but remains inside the sphere, causing the size of the sphere to increase. The thermally expanding microspheres may, for example, have an internal diameter ranging from about 20 μm to about 120 μm after heating. The thermally expanding microspheres may, for example, have an expansion temperature in the range of about 80° C. to about 190° C. The plugging composition may, for example, comprise from about 0 wt % to about 0.3 wt % thermally expanding microspheres. For example, the plugging composition may comprise from about 0 wt % to about 0.2 wt % or from about 0.05 wt % to about 0.15 wt % thermally expanding microspheres.

In certain embodiments, the sintering shrinkage of one face of a ceramic honeycomb structure may be different to the sintering shrinkage of the other face of the ceramic honeycomb structure. For example, the sintering shrinkage of the face of the ceramic honeycomb structure that is in contact with the support during sintering may be lower than the sintering shrinkage of the face of the ceramic honeycomb structure that is not in contact with the support during sintering.

In certain embodiments, the sintering shrinkage of the plugging composition is equal to or up to 0.2 percentage points less than the sintering shrinkage of the face of the ceramic honeycomb structure that is in contact with the support during sintering.

In certain embodiments, the plugging composition used to fill the cell openings on one face of the ceramic honeycomb structure may be different to the plugging composition used to fill the cell openings on the other face of the ceramic honeycomb structure. For example, the sintering shrinkage of the plugging composition used to fill the cell openings of the bottom face of the ceramic honeycomb structure (face in contact with the support) may be lower than the sintering shrinkage of the plugging composition used to fill the cell openings on the top face of the ceramic honeycomb structure (face not in contact with the support).

For example, the mineral component of the plugging composition used to fill the cell openings on one face of the ceramic honeycomb structure may have a different particle size distribution to the mineral component of the plugging composition used to fill the cell openings on the other face of the ceramic honeycomb structure. For example, the plugging composition used to fill the cell openings on one face of the ceramic honeycomb structure may be identical to the plugging composition used to fill the cell openings on the other face of the ceramic honeycomb structure except for the particle size distribution of the mineral component of each plugging composition.

In certain embodiments, the plugging composition used to fill the cell openings on the bottom face of the ceramic honeycomb structure has a sintering shrinkage that is equal to or up to about 0.2 percentage points less than the sintering shrinkage of the cell openings on the bottom face of the ceramic honeycomb structure.

In certain embodiments, the plugging composition used to fill the cell openings on the top face of the ceramic honeycomb structure has a sintering shrinkage that is equal to or up to about 0.2 percentage points less than the sintering shrinkage of the cell openings on the top face of the ceramic honeycomb structure.

The method for producing the ceramic honeycomb structures/articles described herein comprises the steps of:
(a) providing a green honeycomb structure;
(b) optionally drying the green honeycomb structure; and
(c) sintering the green honeycomb structure.

Step (a) may comprise providing an extrudable ceramic mixture and extruding the mixture to form a green honeycomb structure. The preparation of an extrudable mixture from the mineral compounds (optionally in combination with binders, auxiliants etc.) is performed according to methods and techniques known in the art. The raw materials can be mixed in a conventional kneading machine with the addition of a sufficient amount of a suitable liquid phase as needed (normally water), to obtain a paste suitable for extrusion. Additionally, conventional extruding equipment (such as, e.g. a screw extruder) and dies for the extrusion of honeycomb structures known in the art can be used. A summary on the technology is given in the textbook W. Kollenberg (ed.), Technische Keramik, Vulkan-Verlag, Essen, Germany, 2004, which is incorporated herein by reference.

The diameter and arrangement of the green honeycomb structures can be determined by selecting extruder dies of desired shape and size. The honeycomb structure can be made using extrusion dies having pins arranged in a quadrangular symmetry. The corners of the pins may or may not be rounded.

After extrusion, the extruded mass may be cut into pieces of suitable length to obtain green honeycomb structures of desired format. Suitable cutting means for this step (such as wire cutters) are known to the person skilled in the art.

In optional step (b), the extruded green honeycomb structure can be dried according to methods known in the art (e.g. microwave drying, hot-air drying) or the method described herein, prior to sintering.

The (optionally dried) green structure may then be heated in a conventional over or kiln that is suitable to subject the objects to a predefined temperature. When the green honeycomb structure comprises organic binder compound and/or organic auxiliants, usually the structure is heated to a temperature in the range between 200° C. and 300° C. prior to heating the structure to the final sintering temperature, and that temperature is maintained for a period of time that is sufficient to remove the organic binder and auxiliant compounds by means of combustion (for example, between one and three hours).

The sintering step (c) may be carried out at a temperature between 1250° C. and 1700° C., or between 1350° C. and 1600° C., or between 1400° C. and 1580° C., or between 1400° C. and 1500° C. According to an embodiment, the method comprises the step of heating the green honeycomb structure to a temperature in the range of between 650° C. and 950° C., or between 700° C. and 900° C., or between 800° C. and 850° C. prior to the sintering step.

For the use as filters such as diesel particulate filters, the sintered ceramic honeycomb structures, or the green ceramic honeycomb structures can be further processed by plugging, i.e., by closing certain open structures of the honeycomb at predefined positions with additional ceramic mass. Plugging processes thus include the preparation of a suitable plugging mass, applying the plugging mass to the desired positions of the sintered or green ceramic honeycomb structure, and subjecting the plugged honeycomb structure to an additional sintering step, or sintering the plugged green honeycomb structure in one step, wherein the plugging mass is transformed into a ceramic plugging mass having suitable properties for the use in diesel particulate filters. It is not required that the ceramic plugging mass is of the same composition as the ceramic mass of the honeycomb body.

The plugged ceramic honeycomb structure may then be fixed in a box suitable for mounting the structure into the exhaust gas line of a diesel engine.

### Ceramic Skin Composition

There is further provided herein a skin composition for a ceramic honeycomb structure and the use of said composition to coat a ceramic honeycomb structure. There is also provided herein a ceramic honeycomb structure coated with the skin composition. The skin composition is sintered after application to the ceramic honeycomb structure. The skin compositions disclosed herein may also be used on other ceramic materials and structures and are not limited to use of ceramic honeycomb structures.

Skin compositions are often applied to ceramic honeycomb structures in order to improve the properties of the ceramic honeycomb structure prior to and/or during its use (e.g. as a particulate filter). For example, the skin composition may reduce cracking of the honeycomb structure upon heating, increase external mechanical resistance of the honeycomb structure, protect the honeycomb structure from vibration, seal the structure form the passage of liquids and/or gases and/or improve defects (e.g. bow, elephant foot) of the honeycomb structure. The skin layer may also allow the honeycomb structure to better grip its enclose to maintain its position with an overall system.

One problem with using a skin layer on a ceramic honeycomb structure is that it may not interact well with the ceramic honeycomb structure (i.e. poor sticking). The present inventors have surprisingly found that the use of an adhesive in the skin composition can increase sticking of the skin layer to the ceramic honeycomb structure. In certain embodiments, the use of an adhesive in the skin composition can increase sticking of the skin layer to the ceramic honeycomb structure when the skin composition comprises high solids content

The present inventors have also surprisingly found that the skin composition may increase mechanical resistance of the ceramic honeycomb structure. Mechanical resistance is measured using a Dynamometer Mecmesin-Multitest-d with AFG device. The maximum force that can be applied before skin crack or perforation is measured.

For example, the ceramic honeycomb structure having a skin layer may have a mechanical resistance equal to or greater than about 200 N, for example equal to or greater than about 210 N or equal to or greater than about 220 N or equal to or greater than about 230 N or equal to or greater than about 240 N or equal to or greater than about 250 N, when measured at the centre of the longitudinal axis of the ceramic honeycomb structure or at the edge of the ceramic honeycomb structure. For example, the ceramic honeycomb structure may have a mechanical resistance up to about 400 N or up to about 380 N or up to about 360 N or up to about 350 N or up to about 340 N or up to about 320 N or up to about 300 N, when measured at the centre of the longitudinal axis of the ceramic honeycomb structure or at the edge of the ceramic honeycomb structure.

The skin compositions disclosed herein may, for example, comprise one or more inorganic fillers. The inorganic filler may, for example, be selected from alkaline earth metal carbonate (for example dolomite, i.e. CaMg(CO₃)₂), metal sulphate (for example gypsum), metal silicate, metal oxide (for example iron oxide, chromia, antimony trioxide or silica), metal hydroxide, wollastonite, bauxite, talc (for example, French chalk), mica, zinc oxide (for example, zinc white or Chinese white), titanium dioxide (for example, anatase or rutile), zinc sulphide, calcium carbonate (for example precipitated calcium carbonate (PCC), ground calcium carbonate (GCC), for example obtained from limestone, marble and/or chalk, or surface-modified calcium carbonate), barium sulphate (for example, barite, blanc fixe or process white), alumina hydrate (for example, alumina trihydrate, light alumina hydrate, lake white or transparent white), clay (for example kaolin, calcined kaolin, China clay or bentonite), zeolites and combinations thereof. The inorganic filler may be selected from any one or more of the materials listed. The inorganic filler may comprise a blend of any combination of the listed materials. In certain embodiments, the inorganic filler is silica.

The inorganic filler may, for example, be present in the skin composition (e.g. prior to sintering) in an amount ranging from about 50 wt % to about 75 wt %. For example, the inorganic filler may be present in an amount ranging from about 55 wt % to about 70 wt % or from about 60 wt % to about 70 wt % or from about 61 wt % to about 69 wt % or from about 62 wt % to about 68 wt % or from about 63 wt % to about 67 wt %.

The inorganic filler may, for example, have an average particle size (d₅₀) ranging from about 50 μm to about 0.5 mm, for example from about 100 μm to about 0.5 mm, for example from about 200 μm to about 0.5 mm, for example from about 300 μm to about 0.5 mm, for example from about 400 μm to about 0.5 mm.

The skin compositions disclosed herein may, for example, comprise one or more binders. The one or more binders may, for example, be selected from mineral binders, methyl cellulose, hydroxymethylpropyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, alginates and mixtures thereof.

The skin composition may comprise one or more mineral binders. Suitable mineral binders may be selected from the group including, but not limited to, silica, bentonite, aluminum phosphate, boehmite, sodium silicates, boron silicates and mixtures thereof. In certain embodiments, the mineral binder is a stabilized or colloidal mineral binder. This may be defined, for example, by a sedimentation value (wt % of particles that settle out of solution) equal to or less than about 5 wt %.

In certain embodiments, the binder is a silica binder. In certain embodiments, the binder is a sodium stabilised colloidal silica binder.

In certain embodiments, the binder is a mineral binder that is the same mineral as the inorganic filler. In these embodiments, the binder may have a smaller particle size distribution to that of the inorganic filler. For example, the smaller particles may act as a binder to help adhere the inorganic filler particles together.

The binder can be present in the skin composition (e.g. prior to sintering) in a total amount from about 25 wt % to about 35 wt %. For example, the binder may be present in an amount ranging from about 26 wt % to about 34 wt % or from about 27 wt % to about 33 wt % or from about 28 wt % to about 32 wt %. For example, the binder may be present in an amount ranging from about 30 wt % to about 35 wt % or from about 31 wt % to about 34 wt %.

The skin composition may, for example, comprise one or more adhesives (agents that are able to stick to other materials). The one or more adhesives may, for example, be selected from starch products (e.g. cellulose products such as methyl cellulose or cellulose), or water-soluble polysaccharides or any combination thereof.

The adhesive may be present in the skin composition (e.g. prior to sintering) in a total amount ranging from about 0.05 wt % to about 0.5 wt %. For example, the adhesive may be present in the skin composition (e.g. prior to sintering in a total amount ranging from about 0.1 wt % to about 0.4 wt % or from about 0.1 wt % to about 0.3 wt % or from about 0.1 wt % to about 0.2 wt %.

The skin composition may, for example, further comprise one or more wetting agents and/or one or more anti-foaming agents. These agents may, for example, each be present in the skin composition (e.g. prior to sintering) in a total amount ranging from about 0.05 wt % to about 0.5 wt %, for example from about 0.1 wt % to about 0.4 wt % or from about 0.1 wt % to about 0.3 wt %.

The skin composition (e.g. prior to sintering) may, for example, further comprise water. For example, the skin composition (e.g. prior to sintering) may comprise from about 0.5 wt % to about 10 wt % or from about 1 wt % to about 9 wt % or from about 2 wt % to about 8 wt % or from about 3 wt % to about 7 wt % or from about 4 wt % to about 6 wt % water.

In certain embodiments, the skin composition comprises one or more binder(s), one or more inorganic filler(s) and one or more adhesive(s). In certain embodiments, the one or more binder(s) is silica (e.g. colloidal silica). In certain embodiments, the one or more inorganic filler(s) is silica. In certain embodiments, the one or more adhesives is cellulose.

In certain embodiments, the skin composition comprises from about 28 wt % to about 34 wt % binder (e.g. from about 30 wt % to about 34 wt % binder), from about 60 wt % to about 68 wt % inorganic filler (e.g. from about 60 wt % to about 64 wt % inorganic filler) and from about 0.05 wt % to about 0.2 wt % adhesive. In certain embodiments, the one or more binder(s) is silica (e.g. colloidal silica). In certain embodiments, the one or more inorganic particulate mineral(s) is silica. In certain embodiments, the one or more adhesives is cellulose.

The skin composition may, for example, be applied to the ceramic honeycomb structure in any manner known to those in the art. For example, the skin composition may be applied manually or through the use of various mechanical apparatus. For example, the skin composition may be applied by spraying. For example, the skin composition may be applied under sub-atmospheric pressures to facilitate removal of carrier fluid such as water.

The skin composition may, for example, only be applied to the surfaces of the honeycomb structure that do not comprise cell openings (e.g. only to the curved surface of a cylinder and not the faces of the cylinder).

The skin composition is sintered after application to the ceramic honeycomb structure. The sintering may be carried out at the same time as the sintering of the green ceramic honeycomb structure and/or at the same time as the sintering of the plugging composition (where present). Alternatively, the skin composition may be applied and then sintered after the ceramic honeycomb structure and/or plugging composition (where present) have been sintered

The sintering step may be carried out at a temperature between 500° C. and 1700° C., or between 600° C. and 1600° C., or between 700° C. and 1580° C. For example, the sintering step may be carried out at a temperature ranging from about 500° C. to about 1000° C.

The sintered skin layer may, for example, have a thickness ranging from about 500 μm to about 5 mm. For example, the sintered skin layer may have a thickness ranging from about 1 mm to about 4.5 mm or from about 1 mm to about 4 mm or from about 1.5 mm to about 3.5 mm or from about 1.5 mm to about 3 mm or from about 2 mm to about 3 mm. For example, the sintered skin layer may have a thickness ranging from about 0.5 mm to about 3 mm or from about 0.5 mm to about 2 mm or from about 0.5 mm to about 1.5 mm, for example about 1 mm.

### BRIEF DESCRIPTION OF THE FIGURES

Certain embodiments of the invention will now be described, by way of example only and without limitation with reference to the following Figures and Examples, in which:

FIG. 1 depicts a drying chamber that may be used in the drying method disclosed herein, having thirty ceramic green body structures loaded therein;

FIG. 2 shows the temperature (top line) of the isoparaffin mixture and pressure (bottom line) of the chamber during the drying cycle described in Example 1;

FIGS. 3 to 5 are photographs of ceramic honeycomb structures dried using methods not in accordance with the method described herein (microwave drier or conventional oven);

FIG. 6 is a photograph of a ceramic honeycomb structure dried using a method as described herein);

FIGS. 7 and 8 show exemplary cooling heads that may be used in the extrusion methods described herein;

FIG. 9 shows the temperature of the different regions of the external part of the cooling head used in Example 4 and photographs of the honeycomb structures extruded using cooling heads having these temperature settings. No cooling was applied to the left-hand device. Position T₂ of the right-hand device was cooled using water at 15° C.

### EXAMPLES

### Example 1

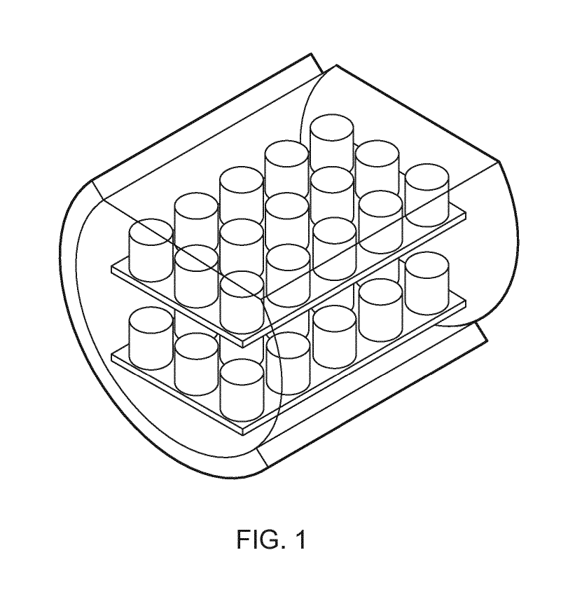

Thirty ceramic honeycomb green bodies having a length of 6 to 10 inches (15.24 to 25.4 cm), a diameter of 5.6 inches (14.224 cm) were loaded in a drying chamber in vertical position on perforated supports (cells of ceramic honeycomb in contact with the perforated support) as shown in FIG. 1.

The pressure inside the chamber was reduced to less than 100 mbar (about 50 mbar) and the chamber was filled with a mixture of isoparaffins (Vossfin™ 2006), which had been preheated to 80° C. The isoparaffin mixture was in constant motion, being evacuated, reheated and reintroduced to the chamber using a vacuum pump.

After about 50 minutes, the isoparaffin mixture (and vaporized water) was removed from the chamber using the vacuum pump. Residual isoparaffin and water is then removed using hot isoparaffin (Vossfin™ 2006) vapour (about 110° C.) and high vacuum (4 mbar).

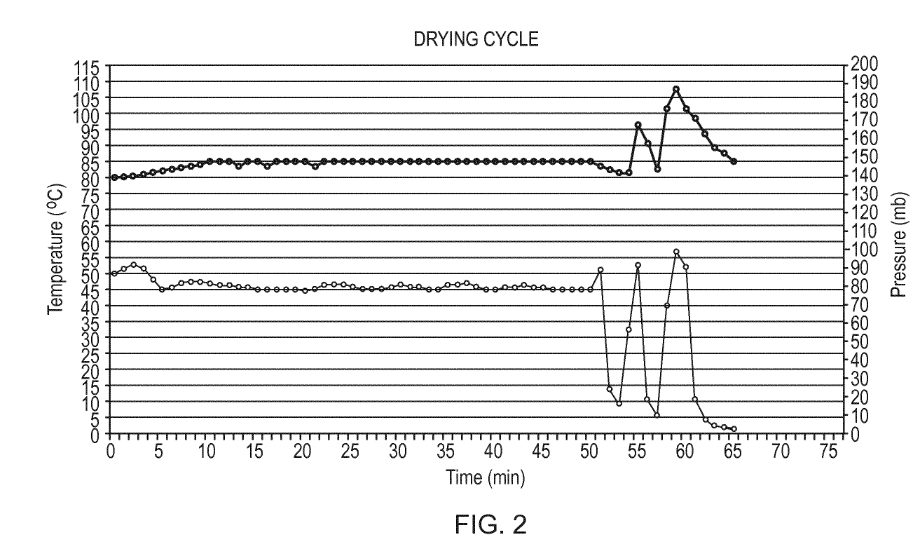

The temperature (top line) and pressure (bottom line) of the drying cycle is shown in FIG. 2.

The water and isoparaffin mixture can be separated by decanting and the isoparaffin mixture can be reused.

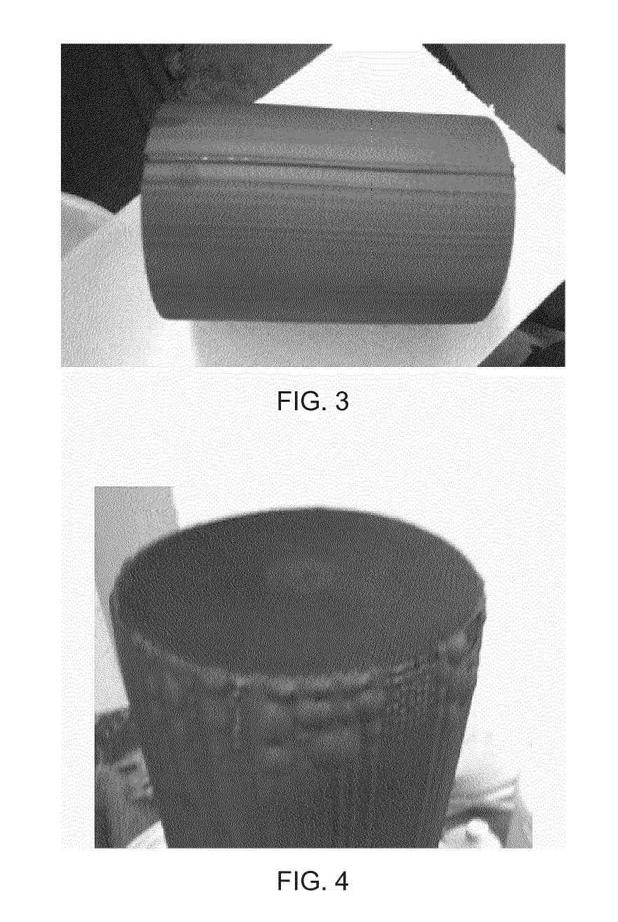

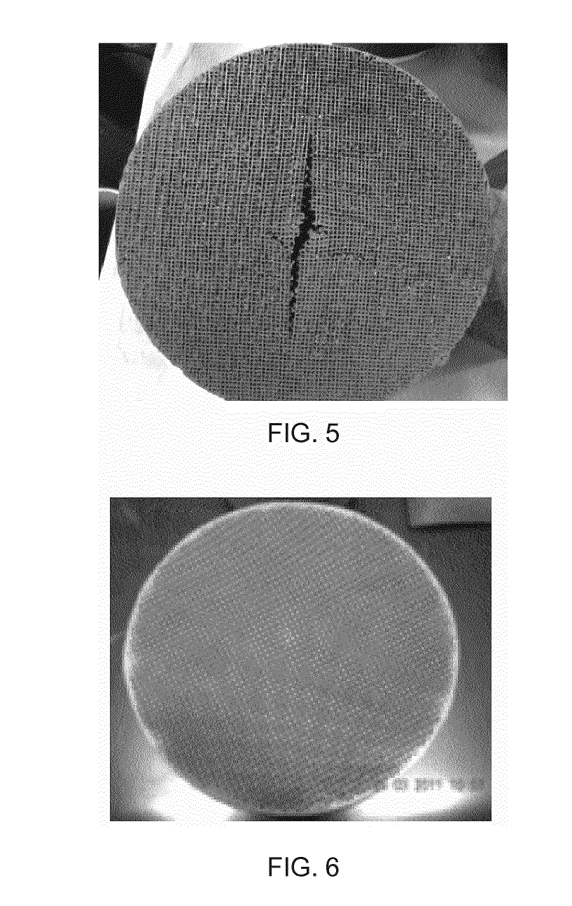

It was found that this drying method resulted in cracked ceramic honeycomb structures less frequently (e.g. see FIG. 6). In contrast, methods of drying the same ceramic honeycomb structures using microwave driers or conventional drying ovens always produced cracked or deformed structures. This is shown in FIGS. 3 to 6.

The theoretical vaporization temperature of water under these conditions is 45° C. It is believed that the circulation of the isoparaffin mixture (heat-transfer liquid) inside the channels of the ceramic honeycombs allowed homogenous drying, avoiding cracking due to differential shrinkage between the outside and the centre of the monolith.

### Example 2

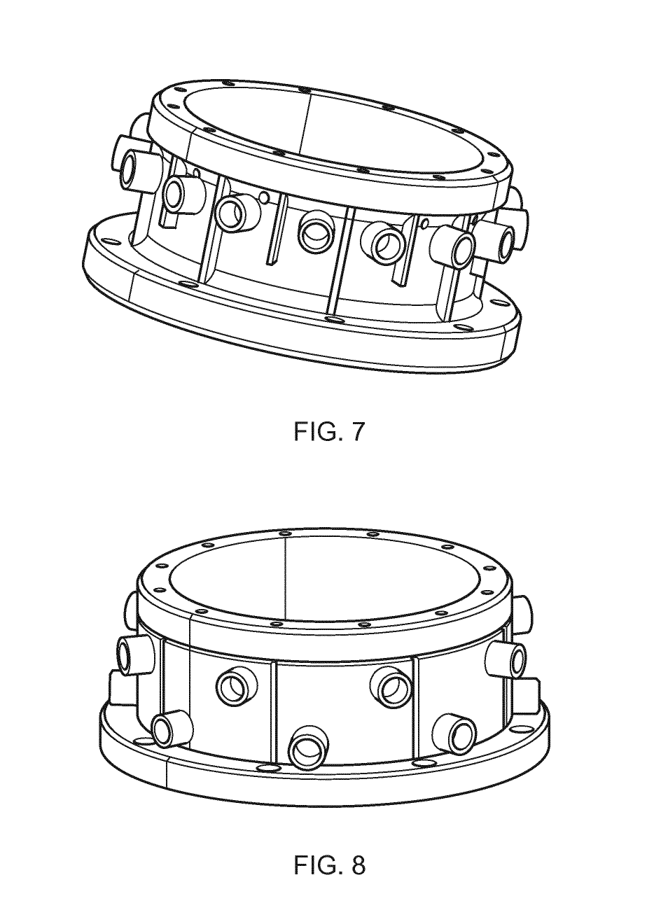

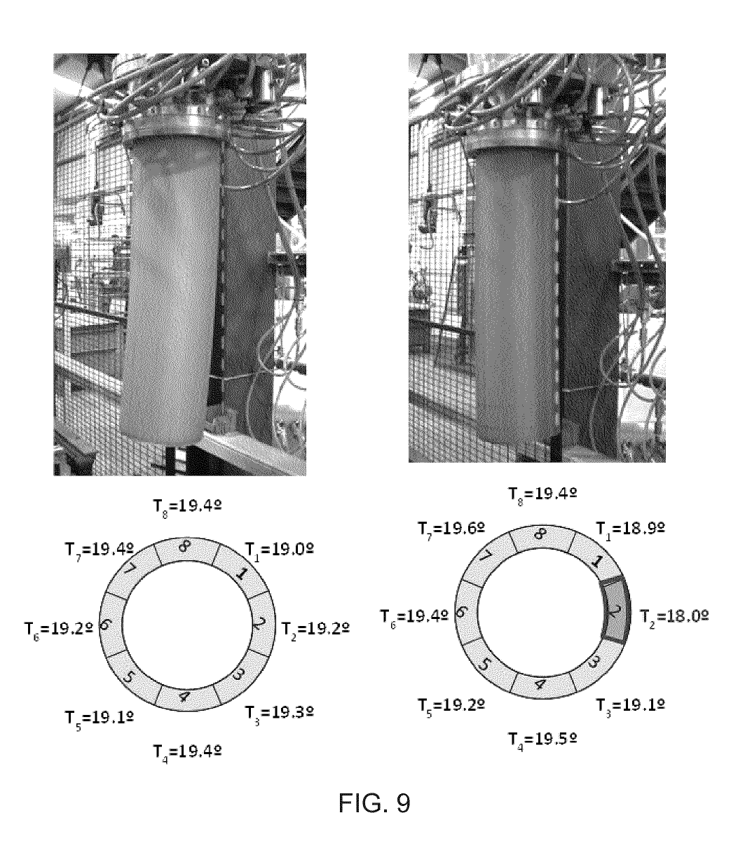

A cooling head as depicted in FIG. 7 was manufactured and a ceramic compositions having the composition of the ceramic honeycomb structure specified in Table 2 below was extruded using the die (ECT extruder 250 mm diameter with a honeycomb die 200 cpsi/14 minch) and other conditions specified in Table 1 below. When the cooling head was used, one region of the device (T₂) was open to the flow of water having a temperature of 15° C. (see right hand column of FIG. 9). The temperature of the different regions on the external part of the device was measured as shown in FIG. 9. The difference in bowing that occurred with and without cooling is shown in the photographs in FIG. 9.

Bowing of a number of ceramic honeycomb structures was monitored with and without cooling. The minimum and maximum bowing obtained for the batch of ceramic honeycomb structures that were prepared was determined. The Pₚₖ process performance parameter as defined by the Six Sigma quality methodology (see https://www.isixsigma.com/tools-templates/capability-indices-process-capability/process-capability-cp-cpk-and-process-performance-pp-ppk-what-difference/#calc, the contents of which are incorporated herein by reference) was also measured. The results are shown in Table 1.

### Example 3

Ceramic honeycomb structures having the composition shown in Table 2 were prepared. These ceramic honeycomb structures were plugged with compositions 1, 2, 3 or 4 as shown in Table 2. First the faces of the ceramic honeycomb structures are covered by an adhesive plastic film. Then, the holes to be plugged are perforated in the plastic film and the plugging composition (paste) is applied to the faces. The plastic is then removed and only the holes that were perforated are plugged. The cells plugged on one face are open on the opposite face. The shrinkage of the plugging compositions and the shrinkage of the top and bottom faces of the ceramic honeycomb structures (median value given) was measured as described above. Leakage and deformation were also monitored visually. The results are shown in Table 2.

TABLE 2

| | Ceramic | | | | | | | | | |
|---|---|---|---|---|---|---|---|---|---|---|
| | Honeycomb | | Plugging | | Plugging | | Plugging | | Plugging | |
| Raw Materials | Structure | | Composition 1 | | Composition 2 | | Composition 3 | | Composition 4 | |
| Andalusite | 25.4 | wt % | 25.4 | wt % | 25.4 | wt % | 25.4 | wt % | 25.4 | wt % |
| (d₅₀ of 30-40 μm) | | | | | | | | | | |
| TiO₂ (anatase) | 28.5 | wt % | 16.1 | wt % | 18.9 | wt % | 20.4 | wt % | 21.6 | wt % |
| (d₅₀ of <1 μm) | | | | | | | | | | |
| TiO₂ (rutile) | — | | 12.4 | wt % | 9.6 | wt % | 8.1 | wt % | 6.9 | wt % |
| (d₅₀ of 15-20 μm) | | | | | | | | | | |
| Alumina | 35.2 | wt % | — | | — | | — | | — | |
| (d₅₀ 75-80 μm) | | | | | | | | | | |
| Alumina | — | | 16.9 | wt % | 16.9 | wt % | 16.9 | wt % | 16.9 | wt % |
| (d₅₀ 25-35 μm) | | | | | | | | | | |
| Alumina | 7.0 | wt % | 25.3 | wt % | 25.3 | wt % | 25.3 | wt % | 25.3 | wt % |
| (d₅₀ 2-4 μm) | | | | | | | | | | |
| Zirconium Oxide | 2.6 | wt % | 2.6 | wt % | 2.6 | wt % | 2.6 | wt % | 2.6 | wt % |
| Magnesium | 1.2 | wt % | 1.2 | wt % | 1.2 | wt % | 1.2 | wt % | 1.2 | wt % |
| Carbonate | | | | | | | | | | |
| Total Solid | 100.0 | wt % | 100.0 | wt % | 100.0 | wt % | 100.0 | wt % | 100.0 | wt % |
| Content | | | | | | | | | | |
| Porous Agent | 12.0 | wt % | — | | — | | — | | — | |
| Starch | — | | 6.50 | wt % | 6.50 | wt % | 6.50 | wt % | 6.50 | wt % |
| Expancel ® | — | | 0.11 | wt % | 0.11 | wt % | 0.11 | wt % | 0.11 | wt % |
| 031 DU 40 | | | | | | | | | | |
| Deflocculant | — | | 0.3 | wt % | 0.3 | wt % | 0.3 | wt % | 0.3 | wt % |
| Darvan 7 | | | | | | | | | | |
| Plasticizers | 3.6 | wt % | — | | — | | — | | — | |
| Lubricant | 0.7 | wt % | — | | — | | — | | — | |
| Water and | 21.0 | wt % | 20.5 | wt % | 20.5 | wt % | 20.5 | wt % | 20.5 | wt % |
| Binders | | | | | | | | | | |

| | | | | | |
|---|---|---|---|---|---|
| Shrinkage (%) | 8.4 | 7.0 | 8.1 | 8.3 | 8.5 |
| CTE 800° C. | <1 | — | — | — | — |
| (×10⁻⁶ ° C.) | | | | | |
| Leakage | — | OK | OK | OK | Not OK |
| (bottom face) | | | | | |
| Deformation | — | Not OK | Not OK | OK | OK |
| (bow) | | | | | |

Plugging composition 3 worked best, with similar shrinkage to the bottom face of the ceramic honeycomb structure and no quality issues.

### Example 4

The skin compositions shown in Table 3 below were prepared and applied to a sintered ceramic honeycomb structure (300 cpsi/12 minch) by spraying. The skin composition was then sintered at a temperature of 700° C. to form a skin layer.

TABLE 3

| | Skin | Skin | Skin | Skin |
|---|---|---|---|---|
| | Composition | Composition | Composition | Composition |
| | 1 (wt %) | 2 (wt %) | 3 (wt %) | 4 (wt %) |
| Sodium | 34.97 | 33.30 | 28.54 | 33.27 |
| Stabilized | | | | |
| Colloidal Silica | | | | |
| Binder | | | | |
| Silica | 64.94 | 61.85 | 66.60 | 61.79 |
| Water-soluble | 0.00 | 0.00 | 0.00 | 0.10 |
| polysaccharide | | | | |
| Adhesive | | | | |
| Ethoxylated | 0.05 | 0.05 | 0.05 | 0.05 |
| Alcohol (non- | | | | |
| ionic | | | | |
| surfactant) | | | | |
| Wetting Agent | | | | |
| Water-based | 0.05 | 0.05 | 0.05 | 0.05 |
| silicone | | | | |
| emulsion Anti- | | | | |
| foaming Agent | | | | |
| Water | 0.00 | 4.76 | 4.76 | 4.75 |
| TOTAL | 100 | 100 | 100 | 100 |

It was found that skin composition 1 gave good application with thin layers (less than 0.5 mm) but not thick layers (less than 2 mm). Skin compositions 2 and 3 did not adhere well to the ceramic honeycomb structures. Skin composition 4 adhered well to the ceramic honeycomb structures.

The mechanical resistance at the centre of the longitudinal axis of the curved surface and close to the plugged face on the curved surface was compared for ceramic honeycomb structures with no skin layer was compared and ceramic honeycomb structures having a skin layer of compositions 3 and 4 of a thickness of about 1 mm. The results are shown in Table 4.

TABLE 4

Mechanical Resistance (N)

| | Centre of | Close to plugged |
|---|---|---|
| | longitudinal axis | faces (on curved |
| Without skin layer | 170 | 140 |
| Skin Composition 3 | 330 | 290 |
| Skin Composition 4 | 250 | 230 |

The following numbered paragraphs define particular embodiments of the present invention:
1. A method for removing water from a ceramic green body, the method comprising:
   immersing the ceramic green body in an organic liquid in a container, wherein the organic liquid is at a temperature sufficient to vaporize water in the ceramic green body; and
   removing the mixture of vaporized water and organic liquid from the container.
2. The method of paragraph 1, wherein the organic liquid continuously flows into and out of the container during immersion.
3. The method of paragraph 1 or 2, wherein the organic liquid and vaporized water are separated upon leaving the container.
4.The method of any one of paragraphs 1 to 3, wherein the organic liquid is re-heated upon leaving the chamber and re-introduced into the container.
5. The method of any one of paragraphs 1 to 4, wherein the temperature of the organic liquid is equal to or greater than the vaporization temperature of water.
6. The method of any one of paragraphs 1 to 5, wherein the temperature of the organic liquid is at least about 5° C. or at least about 10° C. greater than the vaporization temperature of water.
7. The method of any one of paragraphs 1 to 6, wherein the process is carried out in a chamber and the pressure inside the chamber is reduced.
8.The method of any one of paragraphs 1 to 7, wherein the pressure inside the chamber is equal to or less than about 200 mbar, for example equal to or less than about 100 mbar.
9.The method of any one of paragraphs 1 to 8, wherein the pressure inside the chamber is equal to or less than about 100 mbar and the temperature of the organic liquid that is introduced into the chamber is equal to or greater than about 55° C.
10. The method of any one of paragraphs 1 to 9, wherein the organic liquid is not miscible with water.
11. The method of any one of paragraphs 1 to 10, wherein the organic liquid comprises one or more branched-chain alkane(s).
12. The method of any one of paragraphs 1 to 11, wherein the ceramic green body is a ceramic honeycomb structure.
13. The method of paragraph 12, wherein the organic liquid flows through the channels of the ceramic honeycomb structure.
14. The method of paragraph 12 or 13, wherein the ceramic honeycomb structures are placed on perforated supports.
15. The method of any one of paragraphs 1 to 14, wherein the vaporized water and organic liquid are removed using a vacuum pump.
16. The method of any one of paragraphs 1 to 15, wherein method further comprises reducing the pressure and increasing the temperature inside the chamber after the mixture of vaporized water and organic liquid is removed in order to remove residual water and organic liquid.
17. The method of paragraph 16, wherein the pressure is reduced to a pressure equal to or less than about 10 mbar, for example equal to or less than about 4 mbar.
18. The method of paragraph 16 or 17, wherein solvent vapour having a temperature equal to or greater than about 100° C. is introduced into the chamber.
19. A method for extruding a ceramic composition, the method comprising differentially controlling the temperature of different regions of the ceramic composition prior to and/or during extrusion.
20. The method of paragraph 19, wherein the temperature of different regions of the ceramic composition is controlled by independently controlling the temperature of different regions of a device that is in contact with the ceramic composition prior to and/or during extrusion.
21. The method of paragraph 19 or 20, wherein the device comprises at least about 3 or at least about 6 or at least about 8 regions in which temperature can be independently controlled.
22. The method of paragraph 20 or 21, wherein each region of the device comprises an inlet and an outlet for independently supplying a fluid to or from the region.
23. The method of paragraph 22, wherein the temperature of one or more region(s) of the device is controlled by independently delivering a heating fluid or cooling fluid to the region(s).
24. The method of paragraph 23, wherein the fluid is water.
25. The method of any one of paragraphs 20 to 24, wherein each region of the device comprises a temperature sensor.
26. The method of any one of paragraphs 19 to 25, wherein the temperature of the different regions of the ceramic composition are controlled during extrusion to obtain a substantially uniform flow rate.
27. The method of any one of paragraphs 19 to 26, wherein the ceramic composition comprises a methyl cellulose binder.
28. The method of any one of paragraphs 19 to 27, wherein the ceramic composition is extruded to form a ceramic honeycomb structure.
29. A ceramic article made by the method of any one of paragraphs 1 to 28.
30. A device for differentially controlling the temperature of a ceramic composition before and/or during extrusion, wherein the device interacts with the ceramic composition and wherein the device comprises regions in which temperature can be independently controlled.
31. The device of paragraph 30, wherein the device comprises at least about 3 or at least about 6 or at least about 8 regions in which temperature, for example temperature of the device, can be independently controlled.
32. The device of paragraph 30 or 31, wherein each region of the device comprises an inlet and an outlet for independently supplying a fluid to or from the region.
33. The device of any one of paragraphs 30 to 32, wherein each region of the device comprises a temperature sensor.
34. Use of a plugging composition to fill an opening of one or more cells of a ceramic honeycomb structure, wherein the plugging composition has a sintering shrinkage that is equal to or up to about 0.2 percentage points less than the sintering shrinkage of the ceramic honeycomb structure.
35. The use of paragraph 34, wherein the plugging composition comprises a mineral component that has a narrower particle size distribution than the particle size distribution of the mineral component of the ceramic honeycomb structure.
36. The use of paragraph 34 or 35, wherein the difference between the maximum particle size and minimum particle size of the mineral component of the plugging composition may be at least about 20 μm less than the difference between the maximum particle size and minimum particle size of the mineral component of the ceramic honeycomb structure.
37. The use of any one of paragraphs 34 to 36, wherein the mineral component of the plugging composition comprises a mineral component that has a steeper particle size distribution than the mineral component of the ceramic honeycomb structure.
38. The use of any one of paragraphs 34 to 37, wherein the mineral component of the plugging composition has a d₅₀ that is smaller than the d₅₀ of the mineral component of the ceramic honeycomb structure.
39. The use of any one of paragraphs 34 to 38, wherein the mineral component of the plugging composition comprises aluminosilicate or one or more aluminosilicate precursor(s), tialite or one or more tialite precursor(s) and alumina.
40. The use of paragraph 39, wherein the mineral component of the plugging composition further comprises zirconia and/or one or more zirconia precursor(s), and/or further comprises magnesium and/or one or more sources of magnesium.
41. The use of any one of paragraphs 34 to 40, wherein the mineral component of the plugging composition comprises from about 26 wt % to about 31 wt % of tialite and/or one or more tialite precursor(s).
42. The use of any one of paragraphs 34 to 41, wherein the mineral component of the plugging composition comprises from about 19 wt % to about 21.5 wt % of a tialite or tialite precursor having a d₅₀ of less than 1 μm.
43. The use of any one of paragraphs 34 to 42, wherein the mineral component of the plugging composition comprises from about 7 wt % to about 9.5 wt % of a tialite or tialite precursor having a d₅₀ ranging from about 15 μm to about 20 μm.
44. The use of any one of paragraphs 34 to 43, wherein the mineral component of the plugging composition comprises from about 23 wt % to about 26 wt % of aluminosilicate and/or one or more aluminosilicate precursor(s).
45. The use of paragraph 44, wherein the aluminosilicate or aluminosilicate precursor(s) has/have a d₅₀ ranging from about 30 μm to about 45 μm.
46. The use of any one of paragraphs 34 to 45, wherein the mineral component of the plugging composition comprises from about 40 wt % to about 45 wt % alumina.
47. The use of any one of paragraphs 34 to 46, wherein the mineral component of the plugging composition comprises from about 15 wt % to about 20 wt % of an alumina having a d₅₀ ranging from about 25 μm to about 35 μm.
48. The use of any one of paragraphs 34 to 47, wherein the mineral component of the plugging composition comprises from about 23 wt % to about 28 wt % of an alumina having a d₅₀ ranging from about 2 μm to about 4 μm.
49. The use of any one of paragraphs 34 to 38, wherein the mineral component of the plugging composition comprises from about 0 wt % to about 5 wt % zirconia and/or zirconia precursor.
50. The use of any one of paragraphs 34 to 49, wherein the mineral component of the plugging composition comprises from about 0 wt % to about 3 wt % magnesium and/or a magnesium source.
51. The use of any one of paragraphs 34 to 50, wherein the plugging composition comprises one or more binder(s).
52. The use of paragraph 51, wherein the binder is a starch binder.
53. The use of any one of paragraphs 34 to 52, wherein the plugging composition comprises thermally expanding microspheres.
54. The use of any one of paragraphs 34 to 53, wherein the plugging composition used to fill the cell openings of one face of the ceramic honeycomb structure is different to the plugging composition used to fill the cell openings of the other face of the ceramic honeycomb structure.
55. The use of paragraph 54, wherein the mineral components of the plugging compositions used to fill the different faces have different particle size distributions.
56. A ceramic honeycomb article comprising a ceramic honeycomb structure, wherein one or more opening(s) of the honeycomb cells are filled with a plugging composition having a sintering shrinkage equal to or up to about 0.2 percentage points less than the sintering shrinkage of the ceramic honeycomb structure.
57. The ceramic honeycomb article of paragraph 56, wherein the plugging composition comprises a mineral component that has a narrower particle size distribution than the particle size distribution of the mineral component of the ceramic honeycomb structure.
58. The ceramic honeycomb article of paragraph 56 or 57, wherein the difference between the maximum particle size and minimum particle size of the mineral component of the plugging composition may be at least about 20 μm less than the difference between the maximum particle size and minimum particle size of the mineral component of the ceramic honeycomb structure.
59. The ceramic honeycomb article of any one of paragraphs 56 to 58, wherein the mineral component of the plugging composition comprises a mineral component that has a steeper particle size distribution than the mineral component of the ceramic honeycomb structure.
60. The ceramic honeycomb article of any one of paragraphs 56 to 59, wherein the total mineral component of the plugging composition has a d₅₀ that is smaller than the d₅₀ of the mineral component of the ceramic honeycomb structure.
61. The ceramic honeycomb article of any one of paragraphs 56 to 60, wherein the plugging composition comprises aluminosilicate and/or one or more aluminosilicate precursor(s), tialite and/or one or more tialite precursor(s), and alumina.
62. The ceramic honeycomb article of paragraph 61, wherein the plugging composition further comprises zirconia and/or one or more zirconia precursor(s) and/or one or more sources of magnesium.
63. The ceramic honeycomb article of any one of paragraphs 56 to 62, wherein the mineral component of the plugging composition comprises from about 26 wt % to about 31 wt % of tialite or one or more tialite precursor(s).
64. The ceramic honeycomb article of any one of paragraphs 56 to 63, wherein the mineral component of the plugging composition comprises from about 19 wt % to about 21.5 wt % of tialite or a tialite precursor having a d₅₀ of less than 1 μm.
65. The ceramic honeycomb article of any one of paragraphs 56 to 64, wherein the mineral component of the plugging composition comprises from about 7 wt % to about 9.5 wt % of tialite or a tialite precursor having a d₅₀ ranging from about 15 μm to about 20 μm.
66. The ceramic honeycomb article of any one of paragraphs 56 to 65, wherein the mineral component of the plugging composition comprises from about 23 wt % to about 26 wt % of aluminosilicate or one or more aluminosilicate precursor(s).
67. The ceramic honeycomb article of paragraph 66, wherein the aluminosilicate and/or aluminosilicate precursor(s) has/have a d₅₀ ranging from about 30 μm to about 45 μm.
68. The ceramic honeycomb article of any one of paragraphs 56 to 67, wherein the mineral component of the plugging composition comprises from about 40 wt % to about 45 wt % alumina.
69. The ceramic honeycomb article of any one of paragraphs 56 to 68, wherein the mineral component of the plugging composition comprises from about 15 wt % to about 20 wt % of an alumina having a d₅₀ ranging from about 25 μm to about 35 μm.
70. The ceramic honeycomb article of any one of paragraphs 56 to 69, wherein the mineral component of the plugging composition comprises from about 23 wt % to about 28 wt % of an alumina having a d₅₀ ranging from about 2 μm to about 4 μm.
71. The ceramic honeycomb article of any one of paragraphs 56 to 70, wherein the mineral component of the plugging composition comprises from about 0 wt % to about 5 wt % of zirconia or a zirconia precursor.
72. The ceramic honeycomb article of any one of paragraphs 56 to 71, wherein the mineral component of the plugging composition comprises from about 0 wt % to about 3 wt % of magnesium or a magnesium source.
73. The ceramic honeycomb article of any one of paragraphs 56 to 72, wherein the plugging composition comprises one or more binder(s).
74. The ceramic honeycomb article of paragraph 73, wherein the binder is a starch binder.
75. The ceramic honeycomb article of any one of paragraphs 56 to 74, wherein the plugging composition comprises thermally expanding microspheres.
76. The ceramic honeycomb article of any one of paragraphs 56 to 75, wherein the plugging composition used to fill the cell openings of one face of the ceramic honeycomb structure is different to the plugging composition used to fill the cell openings of the other face of the ceramic honeycomb structure.
77. The ceramic honeycomb article of paragraph 76, wherein the mineral components of the plugging compositions used to fill the different faces have different particle size distributions.
78. A plugging composition comprising a mineral component, wherein the mineral component comprises:
   from about 19 wt % to about 21.5 wt % of a tialite precursor having a d₅₀ of less than 1 μm;
   from about 7 wt % to about 9.5 wt % of a tialite precursor having a d₅₀ ranging from about 15 μm to about 20 μm;
   from about 23 wt % to about 26 wt % of one or more aluminosilicate precursor(s) having a d₅₀ ranging from about 30 μm to about 45 μm;
   from about 15 wt % to about 20 wt % of an alumina having a d₅₀ ranging from about 25 μm to about 35 μm;
   from about 23 wt % to about 28 wt % of an alumina having a d₅₀ ranging from about 2 μm to about 4 μm;
   from about 0 wt % to about 5 wt % of a zirconia precursor; and
   from about 0 wt % to about 3 wt % of a magnesium source.
79. The plugging composition of paragraph 79, further comprising one or more binder(s).
80. The plugging composition of paragraph 79 or 80, further comprise a starch binder.
81. The plugging composition of any one of paragraphs 79 to 81, further comprising thermally expanding microspheres.
82. Use of an adhesive in an outer skin composition for a ceramic honeycomb structure.
83. The use of paragraph 83, wherein the adhesive is a starch product.
84. The use of paragraph 83 or 84, wherein the adhesive is cellulose.
85. The use of any one of paragraphs 83 to 85, wherein the outer skin composition comprises an inorganic filler, a binder, a carrier and the adhesive.
86. The use of any one of paragraphs 83 to 86, wherein the outer skin composition comprises from about 25 wt % to about 35 wt % binder.
87. The use of paragraph 86 or 87, wherein the binder is xx.
88. The use of any one of paragraphs 83 to 88, wherein the outer skin composition comprises from about 60 wt % to about 70 wt % inorganic filler.
89. The use of any one of paragraphs 86 to 89, wherein the filler is silica.
90. The use of any one of paragraphs 83 to 90, wherein the outer skin composition comprises from about 0.05 wt % to about 0.5 wt % adhesive.
91. The use of any one of paragraphs 83 to 91, wherein the outer skin composition comprises from about 0.5 wt % to about 10 wt % carrier.
92. The use of any one of paragraphs 86 to 92, wherein the carrier is water.
93. The use of any one of paragraphs 83 to 93, wherein the outer skin composition is applied to the outer surface of the ceramic honeycomb structure and then fired to form an outer skin layer.
94. The use of paragraph 94, wherein the outer skin composition was fired at a temperature ranging from about 600° C. to about 800° C.
95. The use of paragraph 94 or 95, wherein the outer skin composition is fired for 1 hour to 3 hours after it is applied to the ceramic honeycomb structure.
96. The use of any one of paragraphs 94 to 96, wherein the outer skin layer has a thickness ranging from about 0.5 mm to about 1.5 mm.
97. The use of any one of paragraphs 94 to 97, wherein the mechanical resistance at the centre of the ceramic honeycomb structure is equal to or greater than about 200 N.
98. An outer skin composition for a ceramic honeycomb structure comprising a binder, an inorganic filler, a carrier and an adhesive.
99. The outer skin composition of paragraph 99, wherein the adhesive is a starch product.
100. The outer skin composition of paragraph 99 or 100, wherein the adhesive is cellulose.
101. The outer skin composition of any one of paragraphs 99 to 101 comprising from about 25 wt % to about 35 wt % binder.
102. The outer skin composition of any one of paragraphs 99 to 102, wherein the binder is xx.
103. The outer skin composition of any one of paragraphs 99 to 103, comprising from about 60 wt % to about 70 wt % inorganic filler.
104. The outer skin composition of any one of paragraphs 99 to 104, wherein the inorganic filler is silica.
105. The outer skin composition of any one of paragraphs 99 to 105, comprising from about 0.05 wt % to about 0.5 wt % adhesive.
106. The outer skin composition of any one of paragraphs 99 to 106, comprising from about 0.5 wt % to about 10 wt % carrier.
107. The outer skin composition of any one of paragraphs 99 to 107, wherein the carrier is water.
108. A ceramic honeycomb structure comprising a sintered outer skin composition of any one of paragraphs 99 to 108 on its outer surface.
109. A method for removing water from a ceramic green body, the method comprising:
   immersing the ceramic green body in an organic liquid in a container, wherein the organic liquid replaces the water in the ceramic green body; and
   removing the mixture of organic liquid and water from the container.
110. The method of paragraph 109, wherein the organic liquid increases gelification of a binder in the ceramic green body.
111. The method of paragraph 110, wherein the ceramic green body comprises a cellulose binder such as methyl cellulose.
112. The method of any of paragraphs 109 to 111, wherein the organic liquid is miscible with water.
113. The method of any of paragraphs 109 to 112, wherein the organic liquid is a C1-C2 ketone or a C1-C5 alcohol.
114. The method of any of paragraphs 109 to 113, wherein the organic liquid is acetone or propanol (e.g. iso-propanol).
115. The method of any of paragraphs 109 to 114, wherein the organic liquid flows into and out of the container during immersion.
116. The method of any of paragraphs 109 to 115, wherein the temperature of the organic liquid is about room temperature.
117. The method of any of paragraphs 109 to 116, wherein the pressure inside the container is atmospheric pressure.
118. The method of any of paragraphs 109 to 117, wherein the ceramic green body is a ceramic honeycomb structure.
119. The method of paragraph 118, wherein the organic liquid flows through the channels of the ceramic honeycomb structure.
120. The method of paragraph 118 or 119, wherein the ceramic honeycomb structures are placed on perforated supports.
121. The method of any one of paragraphs 109 to 120, wherein the mixture of water and organic liquid are removed using a vacuum pump.

1. A method for removing water from a ceramic green body, the method comprising:
immersing the ceramic green body in an organic liquid in a container, wherein the organic liquid is at a temperature sufficient to vaporize water in the ceramic green body; and
removing the mixture of vaporized water and organic liquid from the container.

2.-20. (canceled)

21. The method of claim 1, wherein the organic liquid continuously flows into and out of the container during immersion.

22. The method of claim 1, wherein the organic liquid and vaporized water are separated upon leaving the container.

23. The method of claim 1, wherein the organic liquid is re-heated upon leaving the chamber and re-introduced into the container.

24. The method of claim 1, wherein the temperature of the organic liquid is equal to or greater than the vaporization temperature of water.

25. The method of claim 1, wherein the temperature of the organic liquid is at least about 5° C. or at least about 10° C. greater than the vaporization temperature of water.

26. The method of claim 1, wherein the process is carried out in a chamber and the pressure inside the chamber is reduced.

27. The method of claim 1, wherein the pressure inside the chamber is equal to or less than about 200 mbar, for example equal to or less than about 100 mbar.

28. The method of claim 1, wherein the pressure inside the chamber is equal to or less than about 100 mbar and the temperature of the organic liquid that is introduced into the chamber is equal to or greater than about 55° C.

29. The method of claim 1, wherein the organic liquid is not miscible with water.

30. The method of claim 1, wherein the organic liquid comprises one or more branched-chain alkane(s).

31. The method of claim 1, wherein the ceramic green body is a ceramic honeycomb structure.

32. The method of claim 31, wherein the organic liquid flows through the channels of the ceramic honeycomb structure.

33. The method of claim 31, wherein the ceramic honeycomb structure is placed on a perforated support.

34. The method of claim 1, wherein the vaporized water and organic liquid are removed using a vacuum pump.

35. The method of claim 1, wherein method further comprises reducing the pressure and increasing the temperature inside the chamber after the mixture of vaporized water and organic liquid is removed in order to remove residual water and organic liquid.

36. The method of claim 35, wherein the pressure is reduced to a pressure equal to or less than about 10 mbar.

37. The method of claim 35, wherein solvent vapour having a temperature equal to or greater than about 100° C. is introduced into the chamber.
